(19) United States
(12) Patent Application Publication
(10) Pub. No.: US 2024/0202564 A1
(43) Pub. Date: Jun. 20, 2024

(54) QUANTUM COMPUTER APPARATUS

(71) Applicant: NEC Corporation, Mina-ku, Tokyo (JP)

(72) Inventor: Aiko YAMAGUCHI, Tokyo (JP)

(73) Assignee: NEC Corporation, Mina-ku, Tokyo (JP)

(21) Appl. No.: 18/537,933

(22) Filed: Dec. 13, 2023

(30) Foreign Application Priority Data
Dec. 16, 2022 (JP) 2022-200784

(51) Int. Cl. G06N 10/40; G06N 10/20

(52) U.S. Cl. CPC G06N 10/40; G06N 10/20

(57) ABSTRACT

A quantum circuit includes a plurality of qubits, a plurality of couplers, a first signal line, and a first selector connected to the first signal line, wherein an individual one of the plurality of qubits is connected to one or more of the plurality of couplers, at least two or more of the plurality of qubits are connected to the first selector, and the at least two or more qubits connected to the first selector are connected respectively to the couplers that are different from each other.

### CROSS REFERENCE TO RELATED APPLICATIONS

This application is based upon and claims the benefit of the priority of Japanese patent application No. 2022-220784, filed on Dec. 16, 2022, the disclosure of which is incorporated herein in its entirety by reference thereto.

### FIELD

This disclosure relates to a quantum computer apparatus. In particular, the disclosure relates to a quantum circuit using a superconducting element or a quantum computer.

### BACKGROUND

A quantum annealing apparatus is disclosed in Non-Patent Literature (NPL) 1 as a quantum computer apparatus using superconducting elements. The quantum annealing apparatus includes a Josephson parametric oscillator (JPO), as a quantum bit (qubit), which includes a SQUID (Superconducting Quantum Interference Device) loop. NPL 2 discloses a coupling scheme for coupling qubits called LHZ (Lechner, Hauke, Zoller).

To ensure a quantum computer apparatus operating correctly, checking of operation and evaluation (testing and evaluation) as to whether each qubit keeps oscillation and whether a resonance frequency of each qubit is at a correct value, etc., are preferably performed. It is also desirable to set correct a strength of each of multiple signals supplied to each of multiple qubits. Signal strength (or intensity) is a signal power expressed in decibels (dB) as a ratio based on 1 mW (milliwatt).

In the quantum computer apparatus including a Josephson parametric oscillator, a qubit is cooled to an extremely low temperature by a refrigerator. A signal generator (signal output part) that supplies a signal (input signal) to the qubit is installed at a room temperature (normal temperature) environment. A signal transmission line from the signal generator to an input node (port) of the qubit, includes, for example, a high-frequency coaxial cable and a circulator. There is a transmission loss in the input signal supplied to the qubit, which is difficult to determine exactly. Thus, by determining a power value with which an input signal is output from the signal output part to supply an appropriate signal power to the qubit, an appropriate input signal can be supplied to an input node of the qubit. This kind of calibration is performed based on a measurement of a reflection signal and a transmission signal for the input signal to the qubit (NPL 3 and NPL 4).
[NPL 1] S. Puri, et al., “Quantum annealing with all-to-all connected nonlinear oscillators,” Nature Comm., 2017
[NPL 2] W. Lechner, et al., “A quantum annealing architecture with all-to-all connectivity from local interactions,” Science Advances 23, 2015, Vol. 1, no. 9, e150083
[NPL 3] T. Yamaji, et al, “Spectroscopic observation of the crossover from a classical Duffing oscillator to a Kerr parametric oscillator,” Phys. Rev. A 105, 023519 (2022)
[NPL 4] S. Masuda, et al., “Theoretical study of reflection spectroscopy for superconducting quantum parametrons,” New J. Phys. 23 093023 (2021)

### SUMMARY

It is an object of the present disclosure to provide a quantum circuit or a quantum computer apparatus that enables a reduction in the number of wirings.

According to one aspect of the present disclosure, there is provided a quantum circuit that includes a plurality of qubits, a plurality of couplers, a first signal line, and a first selector connected to the first signal line. Each qubit is connected to at least one of the plurality of couplers, at least two or more of the plurality of qubits are connected to the first selector. The at least two or more qubits connected to the first selector are connected respectively to the couplers that are different from each other.

There is also provided a quantum computer apparatus using the quantum circuit described above.

According to the disclosure, the number of wirings in a quantum circuit or a quantum computer apparatus can be reduced.

### BRIEF DESCRIPTION OF DRAWINGS

FIG. 1 is a diagram illustrating an example embodiment according to the present disclosure.

FIG. 2 is a diagram illustrating an example of a connection of LHZ scheme.

FIG. 3 is a diagram illustrating a qubit performing a four-body interaction of an example embodiment according to the present disclosure.

FIG. 4 is a diagram illustrating a quantum apparatus of an example embodiment according to the present disclosure.

FIG. 5A is a diagram illustrating an example of a connection during inspection and/or calibration of an example embodiment according to the present disclosure.

FIG. 5B is a diagram illustrating an example of a connection during operation of an example embodiment according to the present disclosure.

FIG. 6 is a diagram illustrating a calculation and measurement switching part of an example embodiment according to the present disclosure.

FIG. 7A is a diagram illustrating an example of a basic unit including four qubits and a coupler of an example embodiment according to the present disclosure.

FIG. 7B is a diagram illustrating an example of a configuration of one of the qubits illustrated in FIG. 7A.

FIG. 7C is a diagram illustrating an example of a configuration of a coupler.

FIG. 8 is a diagram illustrating an example of a connection of the basic unit including four qubits and a coupler in a refrigerator according to an example embodiment of the present disclosure.

FIG. 9 is a diagram illustrating an example of a configuration of a calibration/operation switching part according to an example embodiment of the present disclosure.

FIG. 10A is a diagram illustrating an example of a connection of the calibration/operation switching part during calibration according to an example embodiment of the present disclosure.

FIG. 10B is a diagram illustrating an example of a measurement mode according to an example embodiment of the present disclosure.

FIG. 11 is a diagram illustrating an example of a connection of the calibration/operation switching part during a calculation according to an example embodiment of the present disclosure.

FIG. 12 is a diagram illustrating an example of a basic unit including eight qubits and three couplers of an example embodiment of the present disclosure.

FIG. 13 is a diagram illustrating an example of a connection of the basic unit including the eight qubits and the three couplers in a refrigerator according to an example embodiment of the present disclosure.

FIG. 14A is a diagram illustrating an example of a configuration of a calibration/operation switching part according to an example embodiment of the present disclosure.

FIG. 14B is a diagram illustrating an example of a configuration of a calibration/operation switching part according to an example embodiment of the present disclosure.

FIG. 15A is a diagram illustrating an example of a connection of a calibration/operation switching part during a calibration according to an example embodiment of the present disclosure.

FIG. 15B is a diagram illustrating an example of a connection of a calibration/operation switching part during a calibration according to an example embodiment of the present disclosure.

FIG. 16A is a diagram illustrating an example of a connection of a calibration/operation switching part during a calculation according to an example embodiment of the present disclosure.

FIG. 16B is a diagram illustrating an example of a connection of a calibration/operation switching part during a calculation according to an example embodiment of the present disclosure.

FIG. 17 is a diagram illustrating an example of a basic unit including 43 qubits and 28 couplers according to an example embodiment of the present disclosure.

FIG. 18A is a diagram citing from FIG. 4(b) of NPL 1 and a schematic diagram illustrating a fully connected Ising problem with N=5 logical spins.

FIG. 18B is a diagram citing from FIG. 4(c) of NPL 1 and a schematic diagram illustrating a LHZ arrangement in which N=5 logical spins illustrated in FIG. 18A are mapped to N(N−1)/2 physical spins.

### EXAMPLE EMBODIMENTS

Testing and/or calibration of a plurality of qubits, in particular, which are placed in a refrigerator, encounter/encounters a wiring problem. For example, when measuring a reflection signal from a qubit, an input signal is supplied to a qubit under test/calibration from a signal generator provided at room temperature environment, then, a reflection signal or a transmission signal from the qubit is amplified by an amplifier(s) provided in the refrigerator and taken out therefrom. When performing testing and/or calibration of a plurality of qubits, there may be a case where signal lines are required in correspondence with the number of the qubits. In this case, the number of signal lines that can be installed is limited by, for example, a size of a coaxial connector(s) mounted on a PCB (Printed Circuit Board) on which a quantum chip including a plurality of qubits and/or an interposer are/is mounted. Such components as an amplifier(s), a circulator(s) and an isolator(s) which are placed in a path of a signal output line, are each expensive, and the provision thereof in large quantities is undesirable from viewpoint of cost.

It is also undesirable to provide for each qubit a measurement device(s) such as a network analyzer for testing and/or calibration, from the viewpoint of cost. For this reason, multiple (N) signal lines (wirings) may preferably be connected to measurement devices fewer than N by switching. This means, for example, it would be sufficient to prepare multiple wirings for one (one set of) measurement unit and switch, for example, inside the refrigerator, the wiring which connects to the measurement unit. However, in a quantum annealing apparatus of LHZ scheme, among all of the qubits arranged in a pyramid shape, states of bottom qubits (or qubits arranged on the lowest side) are eventually read out together (simultaneously). In addition, simultaneous readout of at least 4 bits is required for performing adjustment of four-body interaction of each coupler. Accordingly, it is an issue to meet the above requirements and reduce the number of wirings. The above issue is one of examples and the present disclosure is, as a matter of course, not only directed to the above issue. The present disclosure enables to reduce the number of wirings in a quantum circuit or a quantum computer apparatus in various situations, for example, such as wirings arranged in a chamber without a cooling function.

The following describes examples of the present disclosure. In the following description of examples, reference is made to the accompanying drawings in which, by way of illustration, specific examples that can be practiced are shown. It is to be understood that other examples can be used and structural changes can be made without departing from the scope of the various examples. It is noted that in the disclosure, the expression “at least one of A and B” means A, B, or (A and B). The term expressed as “—(s)” includes both singular and/or plural form. According to the present disclosure, a quantum computer apparatus includes output lines (such as readout lines), input lines, pump lines and switches. Number of output lines (lines for readout) equal to a greater one out of the number of qubits on the lowest side in the LHZ arrangement or four. The number of the input lines and the number of the pump lines are each equal to the total number of qubits. By providing switches within the refrigerator and providing a switch outside the refrigerator (a room temperature part), the quantum circuit is enabled to perform quantum annealing operation and calibration for all qubits. Switches disposed both inside the refrigerator and in the room temperature contribute to reduce the number of output lines installed inside the refrigerator. When the number of qubits for simultaneous readout is three, the number of readout lines is four. When the number of bits for simultaneous readout is eight, the number of output lines (lines for readout) is eight.

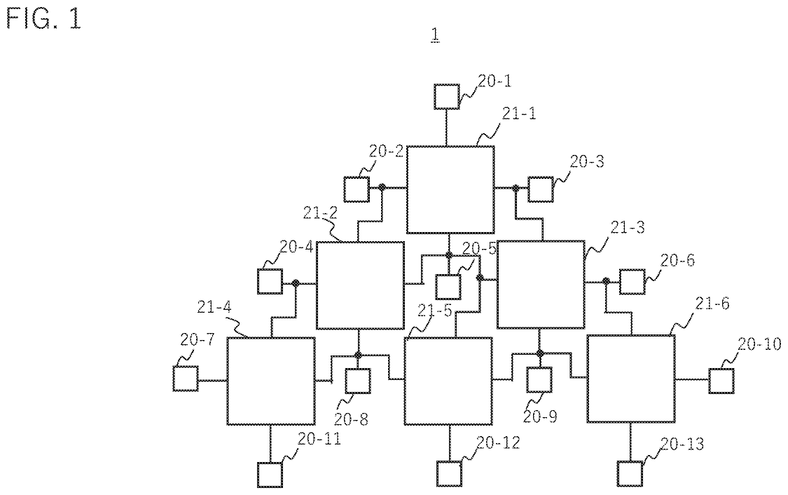

The following describes one example of an exemplary quantum annealing machine according to the present disclosure. FIG. 1 is a diagram illustrating one example of a quantum computer apparatus operating as a quantum annealing machine. In a configuration illustrated in FIG. 1, each coupler 21 of four-body interaction is connected to four qubits 20, respectively, and each qubit includes a Josephson parametric oscillator (JPO). Except where individual JPOs and couplers are designated, JPOs and couplers are referred to by reference numerals 20 and 21, respectively.

A quantum circuit 1 included in the quantum computer apparatus includes a plurality of unit structures (termed basic unit or plaquette). Each of the unit structures includes four JPOs 20 and a coupler 21. At least one JPO 20 is connected to four couplers 21 of the four-body interaction. In a configuration illustrated in FIG. 1, of the JPOs 20 arranged in a pyramid shape, states of JPOs 20-7, 20-8, 20-9, and 20-10 disposed at the bottom thereof are read out in parallel. JPOs 20-11, 20-12, and 20-13 are to be fixed bits.

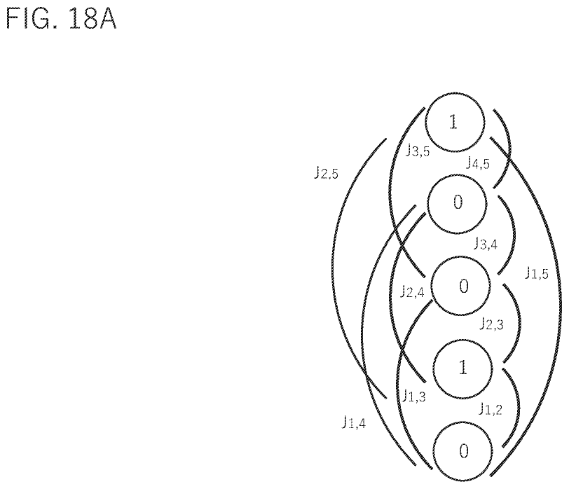

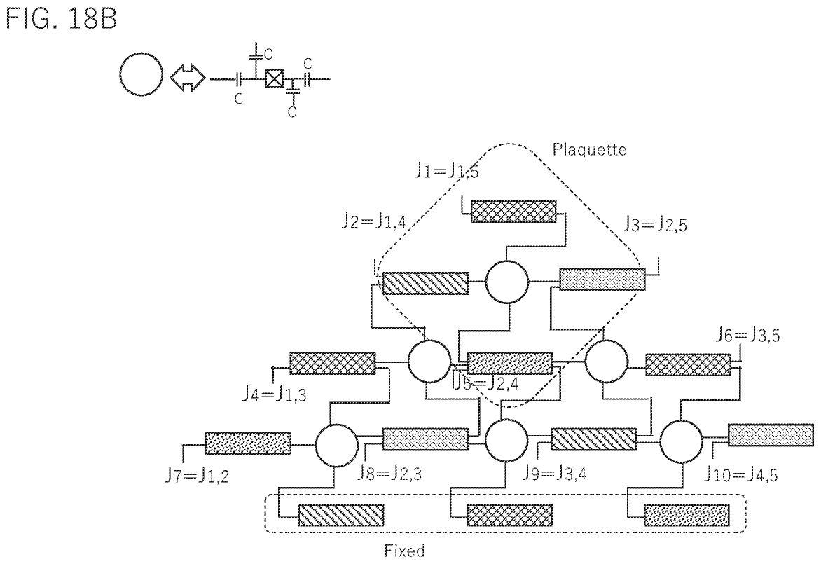

LHZ scheme solves an issue that an optimization problem requires control of long-range interactions between many Ising spins, by of spins mapping to a graph with local interactions. Pairs of N logical spins are mapped(encoded) to K=(N−1)/2 physical spins. A pair of logical spins are aligned as such |0,0> or |1,1> (or anti-aligned |0,1> or |1, 0>). The pair of logical spins J_{i,j} (i≠j=1, . . . , N) is encoded to a physical spin Jₖ (k=1, . . . , K). FIG. 18A illustrates a fully (all-to-all) connected Ising problem with N=5 logical spins. FIG. 18B is a diagram of K=N(N−1)/2K=10 physical spins to which the fully (all-to-all) connected Ising problem with N=5 logical spins in FIG. 18A are mapped (encoded). In FIG. 18B, “O” represents the coupler, and four rectangles connected thereto represent the qubit (JPO). These configure the basic unit. Hamiltonian in the physical spin basis becomes as follows.

H=Σ^{K}ₖ₌₁Jₖσ_{z,k}−Σ<i,j,k,l>Cσ_{z,i}σ_{z,j}σ_{z,k}σ_{z,l} (1)

In equation (1), <i,j,k,l> indicates the nearest-neighbor spins (spins of the basic unit) with constraint imposed thereto, and C is a coupling constant of four physical spins. In FIG. 18B, three physical bits below the lowest side physical bits are fixed bits (spin-fixed). An original combination of the logical bits represented by the lowest side physical bits, excluding the fixed bits, are (i, j)=(1,2), (2,3), (3, 4), (4,5), (5, 6). By reading out the lowest side bits, a combination of whether logical bits 2 and after are in the same state or the opposite state with respect to logical bit 1 can be determined. The configuration in FIG. 18B corresponds to that in FIG. 1.

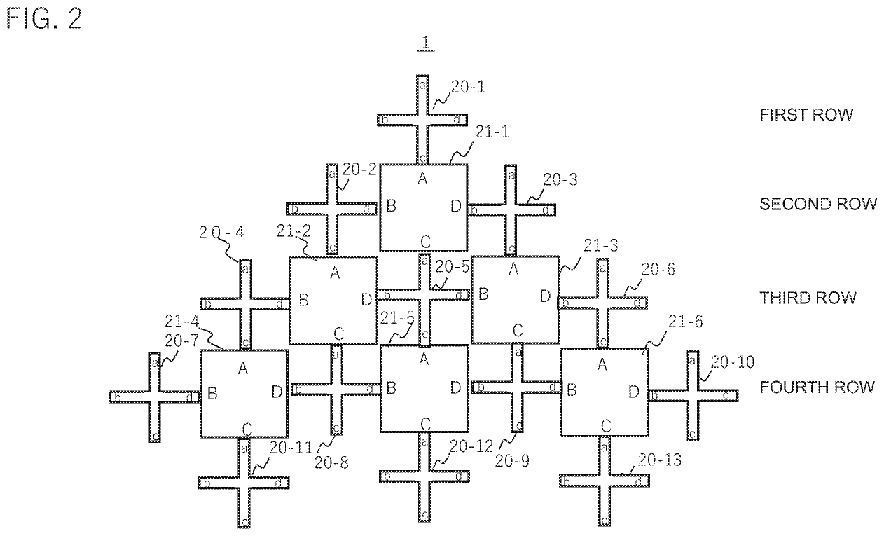

The following further describes an example of couplers and qubits connection configuration of the LHZ scheme with reference to FIG. 2. In FIG. 2, only for simplicity of explanation, each qubit (JPO) in FIG. 1 is to have a planar shape with four arms (electrodes). Each coupler (21-1 to 21-6) disposed in the two-dimensional plane is supposed to have four edges, and each edge is to be A, B, C, and D in counterclockwise direction. Each qubit (20-1 to 20-13) is also supposed to have four edges, and each edge is supposed to be a, b, c, and d in counterclockwise direction. For the sake of explanation, the edge a of each qubit and the edge A of each coupler are to be at the 0:00 (12:00) position of the clock. The qubits are lined up in a certain direction in a plane (from a top to a bottom of a drawing in FIG. 2), with N (N is an integer greater than or equal to two) (four rows) in FIG. 2). These are called qubits of a nth row (n=1, . . . , 4). The n-th row includes n qubits and n−1 couplers, and these qubits and couplers are arranged alternately. That is, an edge B of i-th (i=1, . . . , n−1) coupler is connected to an edge d of i-th qubit (an edge opposing the edge B of the i-th coupler from the left), and an edge D of the i-th coupler (an edge opposite to the edge B of the i-th coupler) is connected to an edge b of (i+1)-th qubit (an edge opposing the edge D of the i-th coupler from the right). To write down more concretely, in nth row, an edge d of a first qubit is connected to an edge B of a first coupler, an edge D of the first coupler is connected to an edge b of a second qubit (snip), and an edge D of (n−1)st coupler is connected to an edge b of a nth qubit. Thus, in the nth row, qubits are always disposed at left and right edges of a coupler. This structure exists with n=1, 2, . . . , M rows (M>2 positive integers). The nth row is disposed on a side opposing an edge c of (n−1)th qubit and an edge C of a coupler.

Regarding a connection between rows, an edge A of a first coupler 21-1 of a second row is connected to an edge c of a first qubit 20-1, and an edge C thereof is connected to an edge a of a second qubit 20-5 of a third row. An edge A of a first coupler 21-2 of the third row is connected to an edge c of a first qubit 20-2 of the second row, and an edge C thereof is connected to an edge a of a second qubit 20-8 of a fourth row. An edge A of a second coupler 21-3 of the third row is connected to an edge c of a second qubit 20-3 of the second row, and an edge C thereof is connected to an edge a of a third qubit 20-9 of the fourth row. An edge A of a first coupler 21-4 of the fourth row is connected to an edge c of a first qubit 20-4 of the third row, and an edge C thereof is connected to an edge a of an opposing qubit 20-11. An edge A of a second coupler 21-5 of the fourth row is connected to an edge c of the second qubit 20-5 of the third row, and an edge C thereof is connected to an edge a of an opposing qubit 20-12. An edge A of a third coupler 21-6 of the fourth row is connected to an edge c of a third qubit 20-6 of the third row, and an edge C thereof is connected to an edge a of an opposing qubit 20-13. Thus, an edge A of i(=1, 2, . . . , n−1)-th coupler of n(=2, . . . , M)-th row is connected to an edge c of i-th qubit of (n−1)-th row, and an edge C of i-th coupler of the (n−1)-th row is connected to an edge a of (i+1)-th qubit of the nth row. A qubit is connected to each edge C of (M−1) coupler(s) in M-th row. In FIG. 2, JPOs 20-11, 20-12, and 20-13 are connected to edges C of three couplers 21-4 to 21-6 in the fourth row, respectively. Each of the JPOs 20-11, 20-12, and 20-13 has an edge a which is connected to each edge C of the couplers 21-4 to 21-6 in the fourth row. The qubit in the M-th row above is called “the lowest side bit”. In FIG. 2, the lowest side bit is JPOs 20-7 to 20-10 in the fourth row.

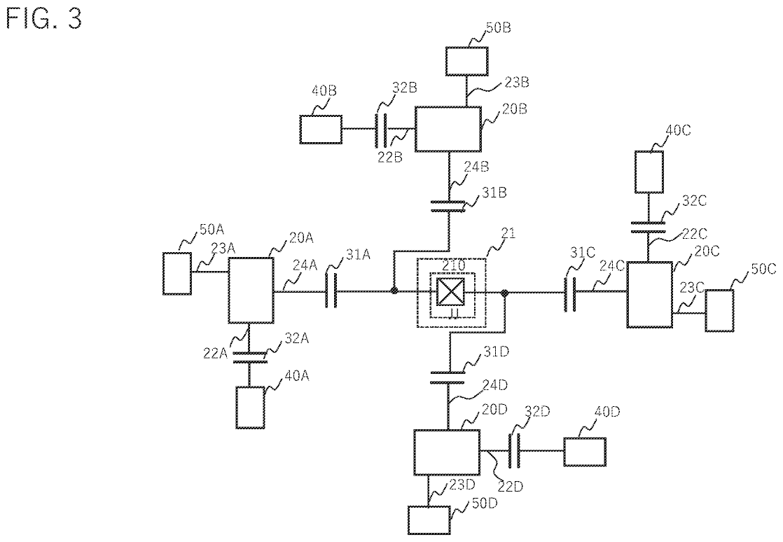

FIG. 3 is a diagram illustrating an example of a connection of the four JPOs 20 and the coupler 21 in quantum circuit 1 illustrated in FIG. 1. In FIG. 3, the four nearest-neighbor JPOs that connect to coupler 21 illustrated in FIG. 1 are indicated by reference numerals 20A, 20B, 20C, and 20D. Coupler connection parts 24A to 24D of the JPO 20A to the JPO 20D and the coupler 21 are capacitively coupled via capacitors 31A to 31D, respectively. Readout circuit connection parts 22A to 22D of the JPO 20A to the JPO 20D are capacitively coupled to readout circuits (signal input parts) 40A to 40D via capacitors 32A to 32D, respectively. The JPO 20A to the JPO 20D are connected to signal output parts 50A to 50D via control lines 23A to 23D, respectively. The signal output parts 50A to 50D generate pump signals (microwave signals) to generate magnetic fluxes that penetrate through a SQUID loop (not shown). A non-linear element 210 of the coupler 21 is an element that can be regarded as a nonlinear LC resonator with a Josephson junction (JJ) as a nonlinear inductance. The non-linear element 210 may be a SQUID including multiple Josephson junctions (JJs).

The coupler 21, the JPO 20A to the JPO 20D, are, for example, implemented as patterns provided in a wiring layer formed by a superconducting material on a substrate. Silicon (Si) is used as the substrate, but an electronic material such as sapphire or a compound semiconductor material (group IV, group III-V and group II-VI) may be used. The substrate is preferably a single crystal but may be a polycrystalline or amorphous. As a material of the line (superconductive wiring material), Nb (niobium) or Al (aluminum) may be used, for example, though not limited thereto. Any metal that becomes superconductive at a cryogenic temperature may be used, such as niobium nitride, indium (In), lead (Pb), tin (Sn), rhenium (Re), palladium (Pd), titanium (Ti), molybdenum (Mo), tantalum (Ta), tantalum nitride, and an alloy containing at least one of the above metals. In order to achieve superconductivity, a coupler circuit is used in a temperature environment of about 10 mK (millikelvin) achieved by a refrigerator.

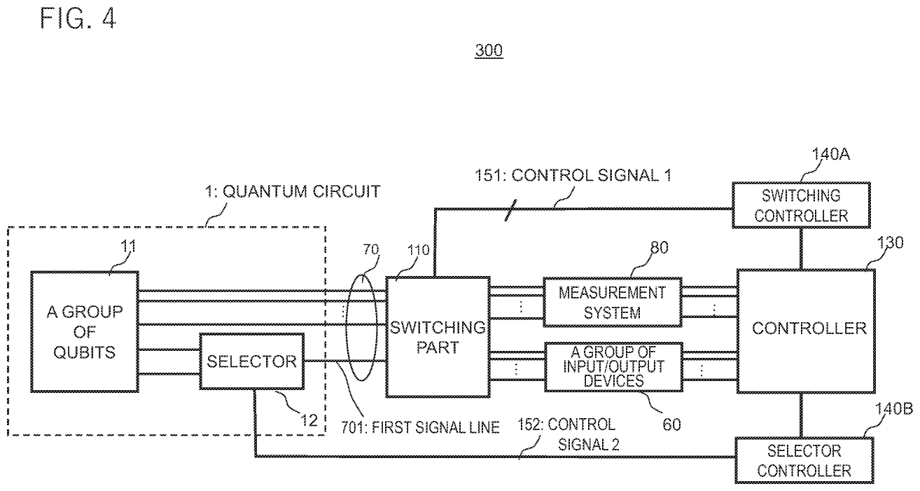

FIG. 4 is a diagram illustrating an example of a configuration of a quantum computer apparatus 200 according to an example embodiment. As explained with reference to FIG. 1 and FIG. 3, etc., a quantum circuit 1 includes a plurality of qubits (a group of qubits 11) made of JPOs, a plurality of couplers (not shown), a first signal line 701, and a selector 12 (first selector) connected to the first signal line 701. As described with reference to FIG. 1 and FIG. 3, each qubit is connected to one or more coupler. At least two or more qubits of the plurality of qubits are connected to the selector 12, and the qubits connected to the selector 12 are respectively connected to couplers that are different from each other.

A switching part 110 connects a measurement system 80 to the quantum circuit 1 in a measurement such as calibration and connects a group of input/output devices 60 to the quantum circuit 1 in operation (e.g., annealing operation). A switching controller 140A uses a first control signal 151 (control signal 1) to perform control for switching between calibration and operation in the switching part 110, control for selecting samples (qubits to be measured), and control for switching measurement mode by a measurement system 80. The quantum circuit 1, which is disposed in an extremely low temperature (cryogenic) environment, is connected to the switching part 110, which is disposed in a room temperature environment, by a transmission system (multiple transmission lines) 70. In the quantum circuit 1, the transmission lines may be configured to include superconducting wirings.

At least two or more qubits in the group of qubits 11 are connected to one end of the selector 12 (first selector) and the selector 12 connects the at least two or more qubits to one end of the first signal line 701 (the transmission line in the transmission system). The other end of the first signal line 701 is connected to the switching part 110.

A selector controller 140B uses a second control signal 152 (control signal 2) to control selection of the qubits connecting to the first signal line 701 by the selector 12. FIG. 4 illustrates an example of including one selector 12 in the quantum circuit 1, but it is of course possible to include multiple selectors. In this case, a configuration is employed in which the second control signal 152 from the selector controller 140B is a bundle of second control signals 152 that control the selection of each selector 12, and the multiple selectors 12 are each configured to connect to multiple first signal lines 701.

A controller 130 controls the group of input/output devices 60 and the measurement system 80, perform any one of measurement and calculation, sets parameters for measurement to the measurement system 80 during measurement, and sets(configures) a sample target qubit setting and a measurement mode to the switching part 110 via a switching controller 140A. The controller 130 may be configured to receive measurement results (e.g., qubit reflection measurement results, etc.) from the measurement system 80 and perform processing to obtain calibration data based on theoretical calculations or the like.

The controller 130 may also be configured to set measurement parameters (signal frequency, etc.) based on calibration data for a signal generator, etc. of the group of input/output devices 60 during annealing operation. An Ising model (Hamiltonian) during annealing operation is expressed, for example, as follows.

$$H ( s ) = A ( s ) {\sum }_{i} {σ}_{i}^{x} + B ( s ) {\sum }_{i , j} {J}_{ij} {σ}_{i}^{2} {σ}_{j}^{2} \qquad ( 2 )$$

where,
σ is a matrix of two rows and two columns (or two-by-two matrix) (Pauli matrix).
The first term on the right side of equation (2) is a transverse magnetic field term causing quantum fluctuations, and the second term on the right side thereof is a usual classical Ising model (objective function to be minimized).
S is a variable representing time (s=t/T, where T is a total computation time and t is an elapsed time during the computation).
A(s) is a function that decreases from a finite value to zero with time.
B(s) is a function that increases from zero to a finite value.
   While the Ising model above is a spin representation, a qubit (JPO) is represented by a creation operator and an annihilation operator. The controller 130 sets parameters (initial values) to the Ising model corresponding to a problem and searches for an optimal solution by varying a term substantially representing a quantum effect (transverse magnetic field A(s)) over time. For example, starting out by superimposing all possibilities due to large quantum fluctuation in the first term (a transverse field term), gradually increasing a weight of a target objective function (the second term), and finally arriving at an optimal solution (a ground state of the Ising model) resulting in only the latter to remain.

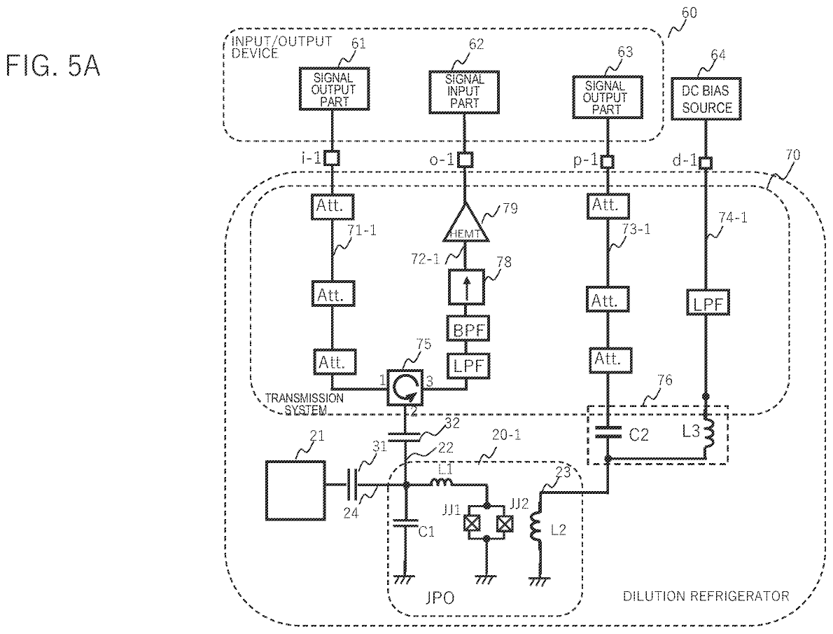

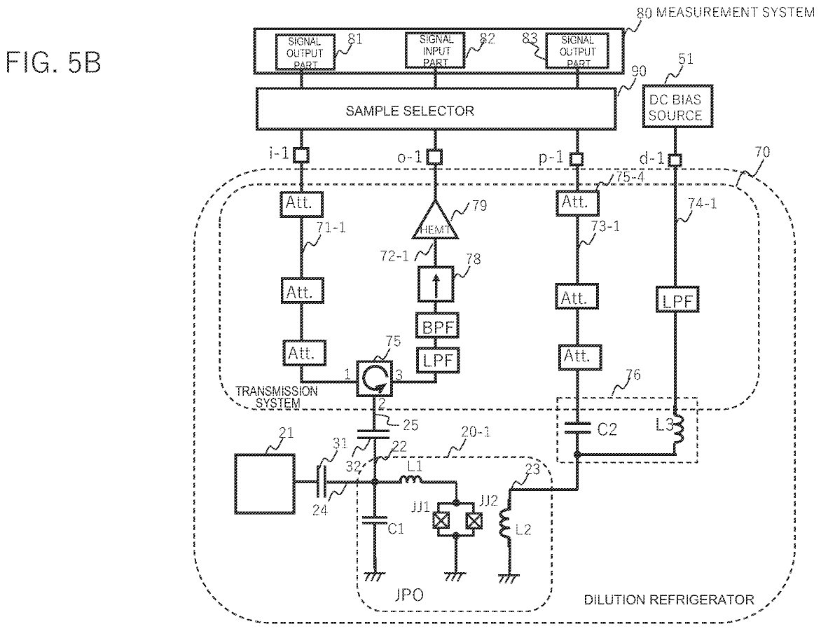

FIG. 5A is a diagram illustrating an example of a JPO connection during operation for an annealing operation in the quantum computer apparatus according to the present example embodiment. In FIG. 5A, one JPO 20-1 is illustrated, but other JPOs are to be connected in the same manner. The JPO 20-1 includes a SQUID that includes two Josephson junctions JJ1 and JJ2 in a loop thereof. One end of the SQUID (ends of the Josephson junctions JJ1 and JJ2) is connected to ground, and the other end of the SQUID (the other ends of the Josephson junctions JJ1 and JJ2) is connected to an electrode (conductor) made of a superconducting material. L1 represents an inductance of the electrode, and C1 represents a capacitance between the electrode and the ground. The JPO 20-1A has a coupler connection part 24 connected to the coupler 21 via a capacitor 31 and a readout circuit connection part 22 connected to a port 2 of a circulator 75 via a capacitor 32. An input line 71-1 (e.g., high-frequency coaxial cable) connected to a terminal i-1 is connected to a port 1 of the circulator 75. The circulator 75 is configured of a passive component, propagates a signal input from the port 1 counterclockwise to the port 2 for output, and propagates a signal input from the port 2 counterclockwise to a port 3 for output. In the circulator 75, a signal flows little or not at all in the reverse direction (clockwise). A signal output from a signal output part (signal generator) 61 of the input/output device 60 is transmitted from the terminal i-1 to the input line 71-1 and is propagated from the port 1 of the circulator 75 counterclockwise to the port 2 for output. A signal (readout signal) transmitted from the readout circuit connection part 22 of the JPO 20-1 via the capacitor 32 to the port 2 of the circulator 75 is propagated counterclockwise to the port 3 and is propagated to an output line 72-1 (e.g., high-frequency coaxial cable) from the port 3 for output. Then, the signal (readout signal) is propagated via a Low Pass Filter (LPF), a Band Pass Filter (BPF), an isolator 78, a High Electron Mobility Transistor (HEMT) amplifier 79, etc., to a terminal o-1, for supply to a signal input part (receiver or measurement device) 62. The input line 71-1 has attenuators (Atts.) for respective temperature ranges. The circulator 75 may be configured to propagate signals clockwise instead of propagating signals counterclockwise. It may be configured with an amplifier (microwave amplifier) between the terminals o-1 and the signal input part 62.

A pump signal (microwave signal) from a signal output part 63, which generates the pump signal, is supplied to a bias T circuit 76 from a terminal p-1 via a pump line (e.g. high-frequency coaxial cable) 73-1. A direct current (DC) signal from a DC bias source 64 is supplied to the bias T circuit 76 from a DC line 74-1. The DC line 74-1 may be made of a twisted pair cable. The input line 73-1 has an attenuator(s) (Atts.) for respective temperature ranges. DC line 74-1 has Low Pass Filter (LPF). The bias T circuit 76 includes a capacitor C2 connected to the pump line 73-1 at one end and an inductor L3 (choke coil) connected to the DC line 74-1 at one end, and a connection point of the other ends of the two is connected to a control line 23. The bias T circuit 76 supplies a Direct Current (DC) bias signal (current) superimposed on a high-frequency signal (microwave signal) by combining the capacitor C2 and the inductor L3 (choke coil). The capacitor C2 passes only high frequency components. The inductor L3 passes DC and frequency components lower than a prescribed frequency and blocks a signal component having higher frequencies than the prescribed frequency. In the bias T circuit 76, the capacitor C2 is connected in series with the signal output part 63, so no DC voltage is applied to the signal output part 63. Therefore, the bias T circuit 76 applies a DC bias signal to the control line 23 without affecting the signal output part 63. The inductor L2 at an end of the control line 23 generates a magnetic flux (including DC bias magnetic flux and AC bias magnetic flux) penetrating through the SQUID loop (loop including Josephson junction JJ1 and JJ2) of the JPO 20-1 by current (DC bias current and microwave current) flowing through the control line 23. An inductor L2 configures an end portion of the control line 23. The inductor L2 may be a transmission line that has one end connected to ground and that is disposed close to the SQUID. Alternatively, the inductor L2 may be a planar spiral inductor disposed opposing the SQUID loop.

By supplying a pump signal with an angular frequency of about twice a resonance angular frequency ω of the JPO 20 from the signal output part 63, the JPO 20 will parametrically oscillate at an angular frequency ω.

FIG. 5B is a diagram illustrating an example of a JPO connection configuration for calibrating the quantum computer apparatus. For simplicity, testing (evaluation) and calibration are simply denoted as “calibration” in the drawings. Referring to FIG. 5B, the quantum computer apparatus is provided with a measurement system 80 that includes a signal output part 81, a signal input part 82, and a signal output part 83. The signal output part 81 outputs a signal for calibration to the JPO 20-1 selected as a measurement target. The signal input part 82 receives a signal from the JPO 20-1. The signal from the JPO 20-1 is an output signal outputted from the JPO 20-1 (output signal wave) or a reflection signal (reflection wave) of an input signal from the JPO 20-1. The signal output part 83 outputs a pump signal to the control line 23 of the JPO 20-1. A sample selector 90 selects a JPO 20-k as a calibration target. The measurement system 80 connects the signal output part 81, the signal input part 82, and the signal output part 83 respectively to terminals i-k, o-k, and p-k, which are connected to the selected kth JPO 20-k. In FIG. 5B, the first (k=1) JPO 20-1 is selected in the sample selector 90. The terminal i-1 is connected to the signal output part 81 and the terminal o-1 is connected to the signal input part 82 during measurement for testing and calibration. Reading out a state of the JPO 20-1 is performed, for example, by supplying an input signal from the signal output part 81 through the circulator 75 (from the port 1 to the port 2) to the JPO 20-1 and supplying a reflection signal from the JPO 20-1 through the circulator 75 (from the port 2 to the port 3) to the output line 72-1 for supply to the signal input part 82. An amplifier (microwave amplifier) may be provided between the terminals o-1 and the signal input part 82.

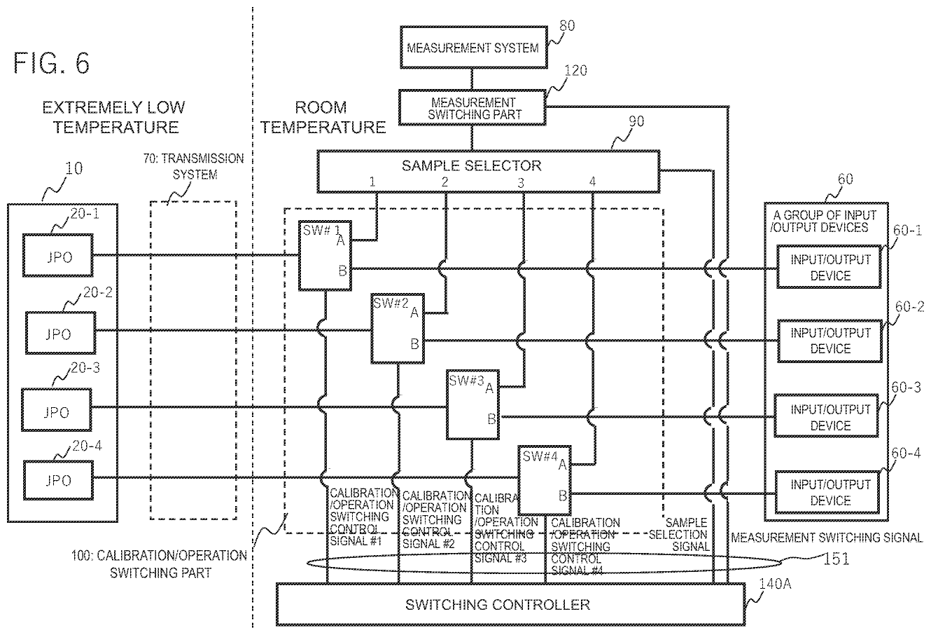

FIG. 6 is a diagram illustrating a configuration in which switching between an operation mode and a calibration mode for four qubits is performed. In a calibration/operation switching part 100, a switch SW #1 connects the JPO 20-1 to an input/output device 60-1 in an operation mode (during operation) and connects the JPO 20-1 to a port 1 of a sample selector 90 in a calibration mode (during calibration), respectively, based on a calibration/operation switching control signal #1 from the switching controller 140A (see FIG. 4).

A switch SW #2 connects the JPO 20-2 to an input/output device 60-2 in an operation mode (during operation) and connects the JPO 20-2 to a port 2 of the sample selector 90 in a calibration mode (during calibration), respectively, based on a calibration/operation switching control signal #2 from the switching controller 140A.

A switch SW #3 connects the JPO 20-3 to an input/output device 60-3 in an operation mode (during operation) and connects the JPO 20-3 to a port 3 of the sample selector 90 in a calibration mode (during calibration), respectively, based on a calibration/operation switching control signal #3 from the switching controller 140A.

A switch SW #4 connects the JPO 20-4 to an input/output device 60-4 in an operation mode (during operation) and connects the JPO 20-4 to a port 4 of the sample selector 90 in a calibration mode (during calibration), respectively, based on a calibration/operation switching control signal #4 from the switching controller 140A.

The sample selector 90 connects one JPO selected as a calibration target to the measurement system based on a sample selection signal from the switching controller 140A. The switching controller 140A may control switching of the sample selector 90 to select, for example, from the JPO 20-1 to the JPO 20-4 in sequence (cyclically) during calibration.

The measurement switching part 120 switches a measurement mode (combination of signals from the measurement system 80, etc.) in the measurement system 80 based on a measurement switching signal from the switching controller 140A.

In FIG. 6, the calibration/operation switching control signals #1 to #4, the sample selection signal, and the measurement switching signal are control signals included in the first control signals 151 in FIG. 4. The coupler 21 (e.g., FIG. 3), which couples the four JPOs with a four-body interaction, is not connected to the input/output devices 60-1 to 60-4 during operation. As described later, during calibration, the coupler 21 shares a transmission line between one of the four JPOs and the calibration/operation switching part 100. Therefore, the coupler 21 is not illustrated in FIG. 6.

The following describes an example of a 4-bit annealing machine. In this case, simultaneous readout (parallel readout) for four bits is required to adjust a four-body interaction. The targets to be calibrated are four qubits and one coupler. In calibration of the coupler, a resonance frequency of the coupler is identified, for example, by measuring a reflection signal from the coupler. One of the four sets of signal lines respectively connected to the four qubits is switched to connect to the coupler using a switch (microwave switch) inside a refrigerator to share the signal line. By using this signal line for measurement of a reflection signal from the coupler, it is possible to calibrate four qubits and one coupler with four signal lines. After calibration, switching in the calibration/operation switching part 100 are performed and pre-operation adjustment may be performed. In the pre-operation adjustment, the simultaneous readout for four qubits connected respectively to the four signal lines is performed to adjust a four-body interaction.

One of examples of the present disclosure is directed to a quantum circuit which includes a plurality of qubits, at least one coupler, a first signal line, and a second selector. A qubit of the plurality of qubits is connected to one or a plurality of couplers of the at least one coupler. One of the plurality of qubits is connected to the first signal line via the second selector. At least one of the plurality of couplers is connected to the second selector. The first signal line may be an output line.

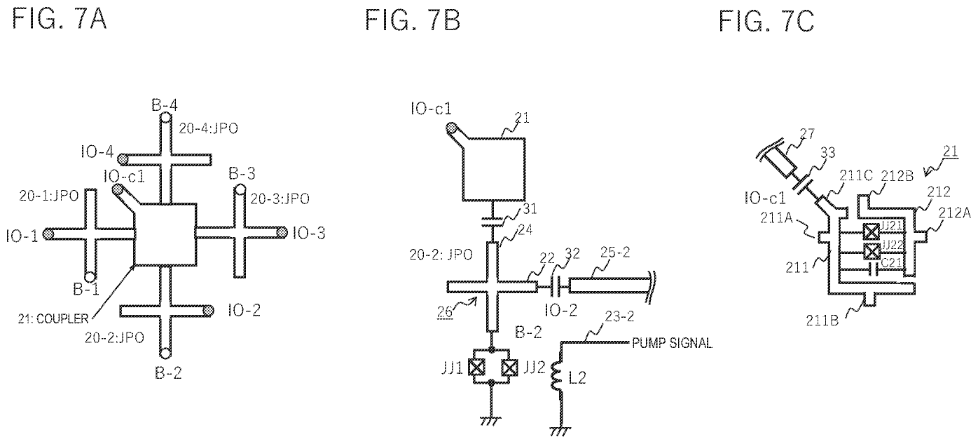

FIG. 7A is a diagram schematically illustrating one example of the four qubits JPO 20-1 to JPO 20-4 and the coupler 21. The four qubits JPO 20-1 to JPO 20-4 and the coupler 21 are formed by deposition of a superconducting material on a substrate (e.g., silicon substrate) of a quantum chip and patterning the superconducting material. In FIG. 7A, an electrode made of a superconducting material is of a cross-shape with four arms of equal length crossing each other at right angles in the center. An input/output port IO-c1 for a control signal of the coupler 21 is a port used to apply a control signal to the coupler 21 and monitor a signal (reflection signal) from the coupler 21 during calibration.

FIG. 7B is a diagram illustrating a connection between the JPO 20-2 and the coupler 21 in FIG. 7A. Ports indicated by a white circle (inductively coupled port) B-2 and a grayed circle (input/output port: capacitively coupled port) IO-2 in the cross-shaped electrode of the JPO 20-2 in FIG. 7A. The JPOs 20-1, 20-3, and 20-4 in FIG. 7A are configured similarly to the JPO 20-2. Referring to FIG. 7B, the coupler connection part 24, which is an end of one arm (first arm) of a cross-shaped electrode 26 of the JPO 20-2, connects to the coupler 21 via the capacitor 31. A SQUID loop with two Josephson junctions JJ1 and JJ2 is connected to an end of the other arm (second arm) of the cross-shaped electrode 26 of the JPO 20-2. In the SQUID loop, one ends of the Josephson junctions JJ1 and JJ2 are connected to ground and the other ends of the Josephson junctions JJ1 and JJ2 are connected in parallel to the end of the other arm (second arm). A magnetic field (magnetic flux) generated by a pump signal supplied to a control line 23-2 is applied to the SQUID loop. The port B-2 designates an inductive coupling between the SQUID of the JPO 20-2 and the control line 23-2 (inductor L2) with one end connected to ground. An input/output port IO-2 at an end portion (readout circuit connection part 22) of a yet another arm (third arm) of the cross-shaped electrode 26 of the JPO 20-2 is coupled via a capacitor 32 to one end of a transmission line 25-2 which has the other end connected to the port 2 of the circulator 75 (see FIG. 5A and FIG. 5B). Both sides of each arm of the cross-shaped electrode 26 of the JPO 20-2 may be surrounded via gaps by a ground plane (ground pattern). A transmission line 25-2, which is connected to the readout circuit connection part 22 via the capacitor 32, and/or the control line 23-2 may be a coplanar line which has both longitudinal sides surrounded via gaps by a ground plane (ground pattern). The transmission line 25-2 of a wiring layer of the quantum chip may be connected to the port 2 of the circulator 75 (FIG. 5A and FIG. 5B) via a coaxial connector and a coaxial cable (both not shown), wherein the coaxial connector is provided on a PCB (Printed Circuit Board; not shown) with terminals (pads) that connect respectively to terminals of the quantum chip.

Referring to FIG. 7C, the coupler 21 includes two Josephson junction JJ21 and JJ22, which are connected in parallel between two opposing electrodes 211 and 212, and a shunt capacitor C21. The Josephson junction JJ21, the electrode 211, the Josephson junction JJ22, and the electrode 212 form a SQUID loop. The shunt capacitor C21 is capacitance between the electrodes 211 and 212. The electrode 211 has an opposing part 211A and 211B that are capacitively coupled to the electrode of JPO 20-1 and JPO 20-2. In addition, the electrode 211 has an opposing part 211C as input/output port IO-c1 coupled via a capacitor 33 to the transmission line 27 configured to transmit a control signal. The electrode 212 have opposing sections 212A and 212B that are capacitively coupled to the electrodes of JPO 20-3 and JPO 20-4. A magnetic field (magnetic flux) generated by a DC current supplied to an inductor of a control line (not shown), may be applied to the SQUID loop including the Josephson junctions JJ21 and JJ22. In this case, the DC bias source 64 and DC line 74-1 illustrated in FIG. 5A and FIG. 5B may be provided for the coupler 21. Alternatively, the coupler 21 can be configured to have a single Josephson junction connected between two opposing electrodes 211 and 212, with a capacitor (shunt capacitor) connected in parallel with the single Josephson junction (in this case, no control line is provided).

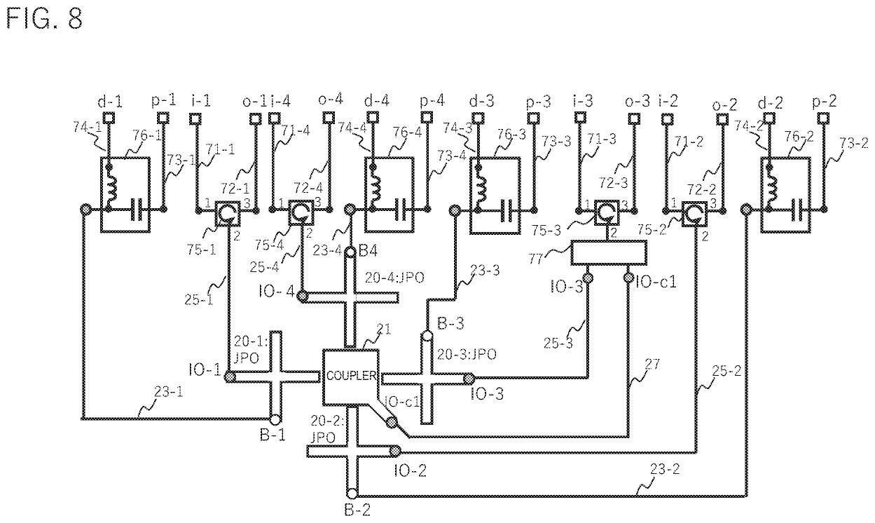

In FIG. 7C, substantially L-shaped opposing electrodes 211 and 212 are illustrated as electrodes of the coupler 21, but the pattern of the electrodes is, as a matter of course, not limited to such a configuration. The two opposing electrodes 211 and 212 of the coupler 21 may be surrounded via a gap by a ground plane (ground pattern) around thereof. The transmission line 27 may be configured as a coplanar line which has both longitudinal sides surrounded via gaps by a ground plane (ground pattern). The transmission line 27 connects to a port 2 of a circulator 75-3 (FIG. 8) via a corresponding switch (selector) 77 (FIG. 8) via a coaxial connector such as a PCB (not shown).

FIG. 8 is a diagram schematically illustrating one example of a connection between the four JPOs 20-1 to 20-4, the coupler 21 in FIG. 7A and the transmission system 70 (FIG. 6). Referring to FIG. 8, a switch (selector) 77 is provided which is configured to select one of an input/output port IO-c1 for supplying a control signal of the coupler 21 and an input/output port IO-3 for signal of the JPO 20-3 to connect to a port 2 of circulator 75-3 based on a second control signal 152 from the selector controller 140B illustrated in FIG. 4. Circulators 75-1, 75-2, and 75-4 have each a port 1 connected the other end of each of input lines 71-1, 71-2, and 71-4, a port 3 connected to the other end of each of output lines 72-1, 72-2, and 72-4, and a port 2 connected to each of input/output ports IO-1, IO-2, and IO-4 of JPO 20-1, 20-2, and 20-4 via transmission lines 25-1, 25-2, and 25-4, respectively. One end of each of the input lines 71-1, 71-2, and 71-4 is connected to each of terminals i-1, i-2, and i-4, respectively. One end of each of the output lines 72-1, 72-2, and 72-4 is connected to each of terminals o-1, o-2, and o-4, respectively. A bias T circuits 76-1 to 76-4 provide signals (microwave signals superimposed on DC signals) to the control lines 23-1 to 23-4, respectively, to generate a magnetic field to be applied to SQUID loops at ports B-1 to B-4 of the JPO 20-1 to 20-4.

One of examples of the present disclosure is a quantum computer apparatus which includes the quantum circuit 1 (FIG. 4) described above and the switching part 110 (FIG. 4). The switching part 110 switches between a first connection configuration and a second connection configuration. The first connection configuration is configured to connect a first signal line and a second signal line to a measurement system. The second connection configuration is configured to connect a first signal line and a second signal line to a group of input/output devices. The first signal line can be an output line. The second signal line can be an input line. The switching part 110 (FIG. 4) can includes a calibration/operation switching part (100 in FIG. 6). The switching part 110 (FIG. 4) may include a sample selector (corresponding to the sample selector 90 in FIG. 6). The switching part 110 (FIG. 4) can includes a measurement switching part (corresponding to the measurement switching part 120 in FIG. 6).

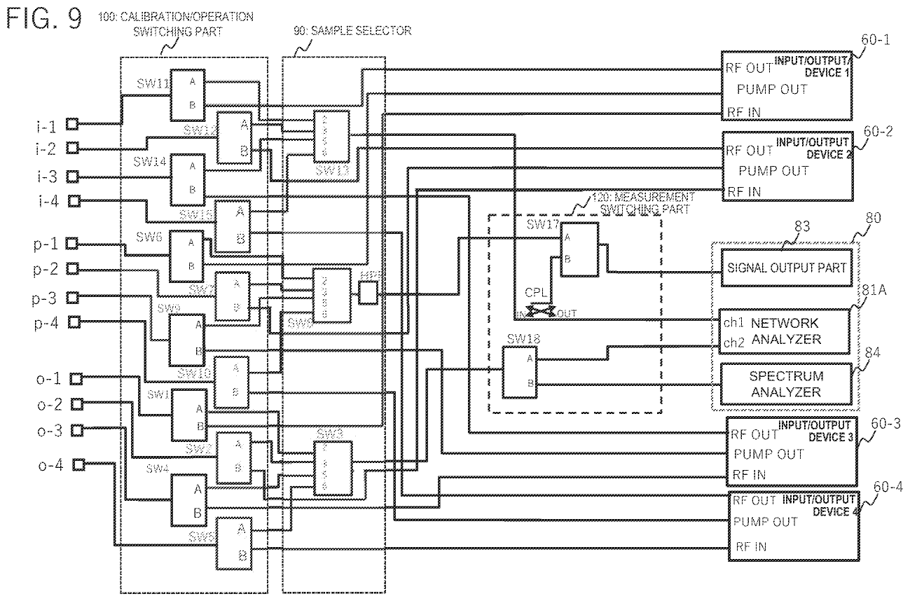

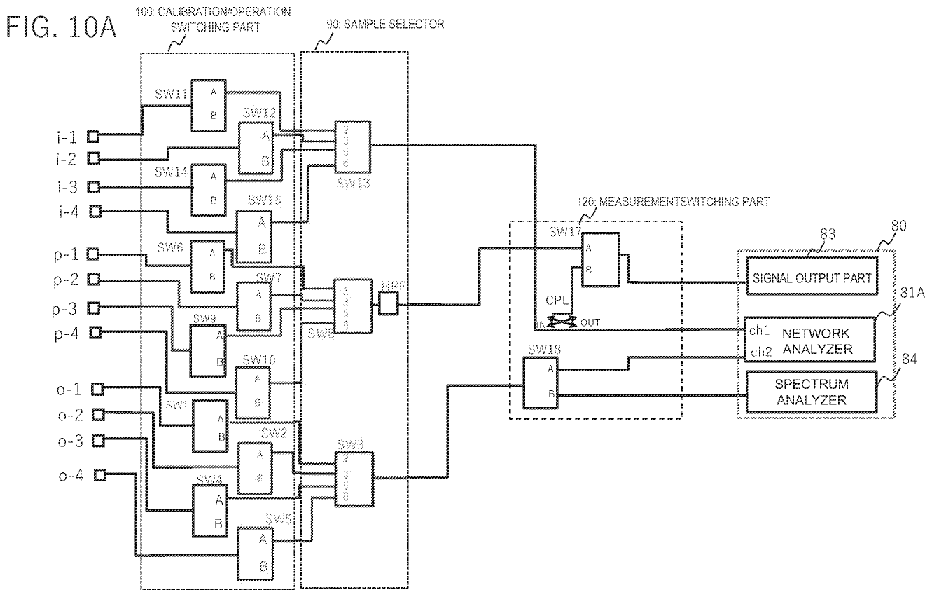

FIG. 9 corresponds to a detailed circuit diagram of FIG. 6. The symbols used in FIG. 6 to indicate intersections are not used in FIG. 9 because they become cumbersome and make the drawing difficult to read when wirings are crowded, as illustrated in FIG. 9. In the calibration/operation switching part 100 in FIG. 9, switches SW11, SW6, and SW1 connecting to terminals i-1, p-i, and o-1, respectively, configure the switch SW #1 in FIG. 6.

Switches SW12, SW7, and SW2 connecting to terminals i-2, p-2, and o-2, respectively, configure the switch SW #2 in FIG. 6.

Switches SW14, SW9, and SW4 connecting to terminals i-3, p-3, and o-3, respectively, configure the switch SW #3 in FIG. 6.

Switches SW15, SW10, and SW5 connecting to terminals i-4, p-4, and o-4, respectively, configure the switch SW #4 in FIG. 6.

SW13, SW8, and SW3 of the sample selector 90 select one of terminals i-1 to i-4, terminals p-1 to p-4, or terminals o-1 to o-4 based on a selection signal (not shown) during calibration, and connect one of first terminal set (i-1, p-1, and o-1), second terminal set (i-2, p-2, and o-2), third terminal set (i-3, p-3, and o-3), or fourth terminal set (i-4, p-4, and o-4) to the measurement system 80.

One example embodiment of the present disclosure is a quantum computer apparatus that includes a switching part (110 in FIG. 4) inside which a sample selector (e.g., 90 in FIG. 9) to select the qubit to be measured, and a measurement switching part (e.g., 120 in FIG. 9) that switches mode of measurement are provided. The measurement switching part (120 in FIG. 9) switches between at least two modes among a first measurement mode, a second measurement mode, and a third measurement mode. In first measurement mode, a signal from a first signal output part (81A in FIG. 9) of the measurement system (80 in FIG. 9) is supplied to a second signal line connected to a qubit selected by the sample selector (90 in FIG. 9), a signal from a second signal output part (83 in FIG. 9) of the measurement system (80) is supplied to a qubit selected by the sample selector (90) as a pump signal, and a signal from a first signal line connected is supplied to a qubit to a first signal input part (ch2 of 81A in FIG. 9). In the second measurement mode, a combined signal from a first signal output part (ch1 of 81A in FIG. 9) and the second signal output part (83) of the measurement system (80) is supplied to the second signal line connected to the qubit selected by the sample selector (90), and a signal from the first signal line connected to the qubit selected by the sample selector (90) is supplied to the first signal input part (ch2 of 81A in FIG. 9) of the measurement system (80). In the third measurement mode, a signal from the second signal output part (83) of the measurement system (80) is supplied to the qubit selected by the sample selector (90) as a pump signal, and a signal from the first signal line connected to the qubit selected by the sample selector (90) is supplied to the second signal input part (84 in FIG. 9) of the measurement system (80). The first signal line may be an output line or an input/output line. The second signal line may be an input line or input/output line.

The measurement system 80 includes a signal output part 83 that outputs a microwave signal, a network analyzer 81A, and a spectrum analyzer 84. The network analyzer 81A includes a built-in signal source and receiver that outputs a signal from a channel 1 (ch1) and receives a signal at a channel 2 (ch2). The signal source and receiver of the network analyzer 81A correspond to the signal output part 81 and the signal input part 82 in FIG. 5B. The signal output part 83 in FIG. 9 may correspond to the signal output part 83 in FIG. 5B.

In the measurement switching part 120, switch SW17 and switch SW18 both switch an output terminal thereof to the terminal A or the terminal B according to the measurement mode based on a first control signal 151 in FIG. 4 (measurement switching signal in FIG. 6).

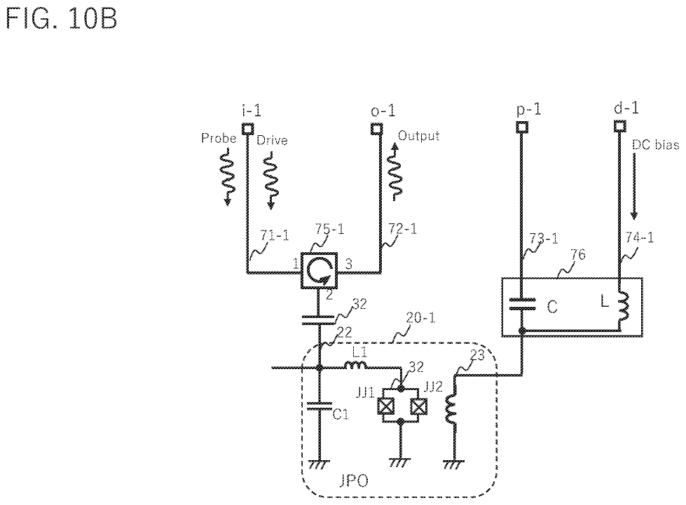

FIG. 10A is a diagram illustrating a connection of in the circuit configuration of FIG. 9 in the calibration mode. In the first measurement mode, the switch SW17 of the measurement switching part 120 connects an input terminal thereof to the terminal A based on a measurement switching signal which is illustrated in FIG. 6. As a result, an output signal (microwave signal) of the signal output part 83 which generates a pump signal, is supplied via a high-pass filter (HPF) to the switch SW8 of the sample selector 90 and is suppled to one of the terminals p-1 to p-4 selected by the switch SW8. An output signal from the channel 1 (ch1) of the network analyzer 81A is supplied to the switch SW13 of the sample selector 90 and is suppled to one of the terminals i-1 to i-4 selected by the switch SW 13 based on a sample selection signal which is illustrated in FIG. 6.

The switch SW18 of the measurement switching part 120 switches an output terminal to the terminal A based on the measurement switching signal illustrated in FIG. 6, and supplies, to a channel 2 (ch2) of the network analyzer 81A, a signal (at o-3, the signal is either a reflection signal from the JPO 20-3 or a reflection signal from the coupler 21) transmitted to the terminal selected from among the terminals o-1 to o-4 by the switch SW3 of the sample selector 90. This configuration allows, for example, a calibration of a pump signal supplied to a terminal selected from among the terminals p-1 to p-4 as the calibration target. This configuration also enables to obtain a Q value of the JPO selected as the calibration target, based on a result of a reflection measurement which has been measured with no additional drive signal.

In the second measurement mode, the switch SW17 of the measurement switching part 120 switches an output to the B terminal based on a measurement switching signal illustrated in FIG. 6. As a result, an output signal (microwave signal) of the signal output part 83 combined with an output signal (microwave signal) from the channel 1 (ch1) of the network analyzer 81A at a directional coupler CPL, is supplied to an input terminal of the switch SW13 of the sample selector 90 and is supplied to one of the terminals i-1 to i-4 selected by the switch SW13. The directional coupler CPL is a passive device and operates in both forward and reverse directions. As illustrated in FIG. 10A, in the reverse direction (IN and OUT ports are reversed), a signal is coupled with a main path signal (In FIG. 10A, an output signal from the channel 1 (ch1) of the network analyzer 81A) according to a directionality and coupling degree of the CPL, and the signal coupled is supplied to switch SW13 of the sample selector 90 to input one of the selected terminals i-1 to i-4 based on a sample selection signal which illustrated in FIG. 6.

The switch SW 18 of the measurement switching part 120 switches an output terminal to the terminal A based on a measurement switching signal which is illustrated in FIG. 6 and supplies, to the channel 2 (ch2) of the network analyzer 81A, a signal (at the terminal o-3, either a reflection signal from the JPO 20-3 or a reflection signal from the coupler 21) transmitted to the terminal selected from among terminals o-1 to o-4 by the switch SW3 of the sample selector 90.

FIG. 10B is a diagram illustrating the second measurement mode. FIG. 10B illustrates the connection configuration corresponds to a case where the JPO 20-1 is selected in the sample selector 90. A microwave signal (probe signal which is swept over a predetermined frequency range) of angular frequency ω_{probe} from the network analyzer 81A and a microwave (drive signal) signal of angular frequency ω_{d} from the signal output part 83 are superimposed, is supplied via the terminal i-1 and an input line 71-1 to the port 1 of the circulator 75-1, propagated to the port 2 and transmitted via the capacitor 32 to the JPO 20-1. An output signal (reflection signal) from the JPO 20-1 is supplied to the port 2 of the circulator 75-1, propagated to the port 3 and then supplied via an output line 72-1 to the terminal o-1.

In the third measurement mode, the switch SW17 of the measurement switching part 120 switches an output terminal to the terminal A based on a measurement switching signal illustrated in FIG. 6. As a result, an output signal of the signal output part 83 that outputs a pump signal of angular frequency ωₚ is supplied via a high pass filter (HPF) to an input terminal of the switch SW 8 of the sample selector 90. A channel 1 (ch) of the network analyzer 81A is connected to one of the terminals i-1 to i-4 via the switch SW13 of the sample selector 90. No signal is output from the channel 1 (ch) of the network analyzer 81A, and it is not used for measurement. The switch SW18 of the sample selector 90 switches an output terminal to the terminal B based on a sample selection signal illustrated in FIG. 6 and supplies, to the spectrum analyzer 84, a signal (at the terminal o-3, the signal is either a reflection signal from the JPO 20-3 or a reflection signal from the coupler 21) transmitted to the terminal selected from among terminals o-1 to o-4 by the switch SW3. In the spectrum analyzer 84, a parametric oscillation can be evaluated by observing spectrum of ½ frequency of the pump signal input from the signal output part 83.

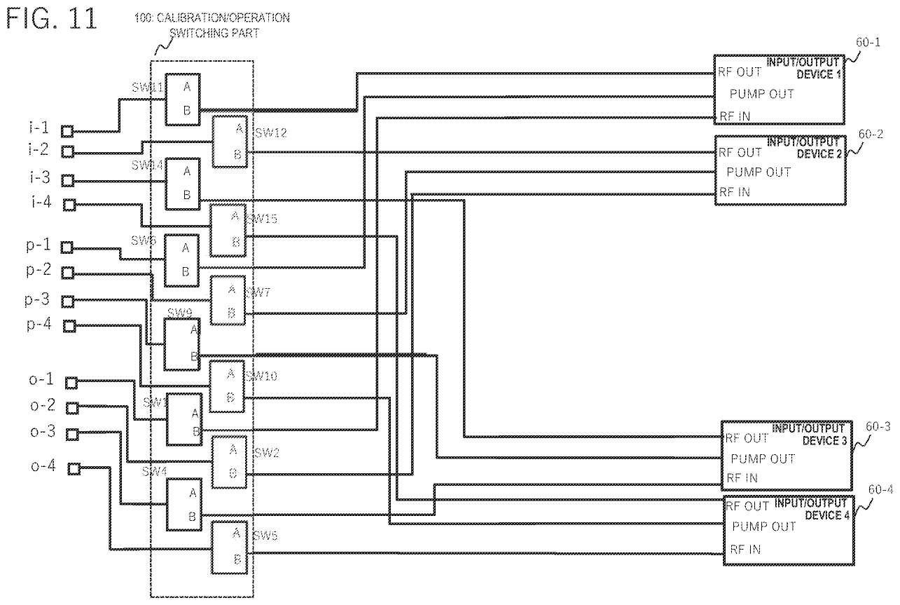

FIG. 11 is a diagram illustrating a connection configuration of a circuit configuration of FIG. 9 during operation. A switch of the calibration/operation switching part 100 is switched to a terminal B based on a calibration/operation switching control signal illustrated in FIG. 6. The terminals i-1 to i-4 are connected to output terminals (RF OUT) of the signal output part of the input/output device 60-1 to 60-4, respectively. The terminals o-1 to o-4 are connected to the input terminals (RF IN) of the signal output part of the input/output device 60-1 to 60-4, respectively. The terminals p-1 to p-4 are connected to the pump signal output terminals (PUMP OUT) of the signal output part of the input/output devices 60-1 to 60-4, respectively.

As one of examples the present disclosure, there is provided a quantum circuit which includes a plurality of qubits, a plurality of couplers a first signal line, and a first selector connected to the first signal line. Each qubit is connected to one or more coupler(s) of the plurality of couplers. At least two or more qubits of the plurality of qubits are connected to the first selector. The at least two or more qubits connected to the first selector are each connected to a coupler different from each other.

As one of examples of the present disclosure, the quantum circuit includes four of the first signal lines. Four of the qubits are connected to each coupler. The four qubits are connected to the four first signal lines, respectively, which are different from each other. At least one of the four qubits is connected to the first signal line via the first selector.

As one of examples of the present disclosure, in the quantum circuit, the qubit connected to the first selector is connected to the first selector via the first circulator. The quantum circuit further includes a second signal line connected to the qubit via the first circulator.

In the quantum circuit, the first signal line may be an output line. The second signal line can be an input line. The selector can be a switch.

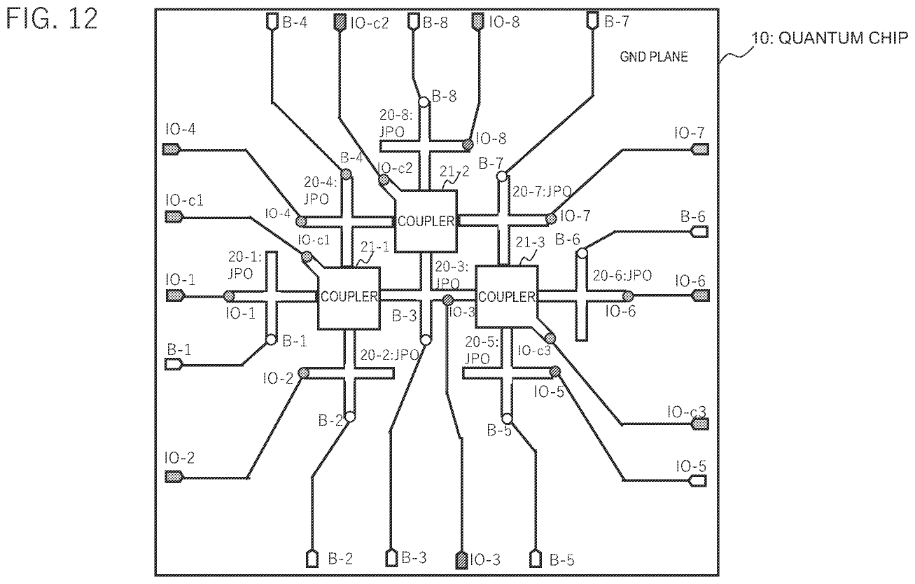

FIG. 12 is a diagram illustrating an arrangement of an annealing machine which includes eight qubits. In FIG. 12, an example of a circuit pattern of a wiring layer of a quantum chip 10 is illustrated schematically. The wiring layer of the quantum chip 10 is formed by, for example, deposition of a superconducting material on a substrate and patterning the superconducting material. In FIG. 12, SQUIDs (not shown) each provided with two Josephson junction in a loop are connected to ports B-1 to B-8 of JPO 20-1 to 20-4, respectively, and IO-1 to IO-8 are input/output ports. IO-c1 to IO-c3 are input/output ports for control signals of couplers 21-1 to 21-3. The ports B-1 to B-8, IO-1 to IO-8, and IO-c1 to IO-c3 are wired to terminals (pads) for external connection, respectively. As a non-limiting example, in the quantum chip 10 illustrated in FIG. 12, in the wiring layer, JPOs 20-1 to 20-8, couplers 21-1 to 21-3, terminals, and transmission lines (coplanar lines) connecting between the terminals and ports are arranged to have respective edges opposed via gaps to edges of a ground plane (GND plane). In FIG. 12, terminals that connect to ports have the same name as the ports. The terminals of the quantum chip 10 are connected, for example, to corresponding terminals of a substrate of a PCB (not shown) and are connected from a connector provided on the PCB to a circulator and so forth. An example of the circuit pattern illustrated in FIG. 12 is only for illustrative purposes, and a terminal layout and wiring connections are, as a matter of course, not limited to the example illustrated in FIG. 12. The terminals are provided in a periphery of the wiring layer of the quantum chip 10 in FIG. 12. Alternatively, pads may be provided within an area surrounded by the periphery of the wiring layer of the quantum chip 10, and the pads are connected to pads of a wiring layer of a second quantum chip (interposer) (not shown) that is mounted opposing the quantum chip 10 with bumps such as metal protrusions, wiring, etc. may be routed on the wiring layer of the second quantum chip (interposer) (not shown), and connections may be made from the terminals of the second quantum chip (interposer) to the PCB.

In FIG. 12, with eight qubits, three couplers 21, simultaneous readout wiring for four bits allows calibration, pre-operation adjustment, and annealing operation (computation). A coupler 21-1 is capacitively coupled to one end of one arm of each of the cross-shaped electrodes of JPOs 20-1, 20-2, 20-3, and 20-4. Therefore, simultaneous (parallel) read out of JPOs 20-1, 20-2, 20-3, and 20-4 are needed. Thus, JPOs 20-1, 20-2, 20-3, and 20-4 are configured to connect to separate lines, respectively. Similarly, the coupler 21-2 is capacitively coupled to one end of one arm of each of the cross-shaped electrodes of the JPOs 20-3, 20-4, 20-7, and 20-8 and the coupler 21-3 is capacitively coupled to one end of one arm of each of the cross-shaped electrodes of the JPOs 20-3, 20-5, 20-6, and 20-7. Each coupler is made to be measurable. In this way, pre-operation adjustment by simultaneous readout of four bits can be performed sequentially for the three couplers. During annealing operation, JPO 20-1, 20-3, and 20-6 of three bits on the lowest side of the LHZ arrangement need to be able to be read simultaneously and measured independently. In this case, the number three of the qubits (JPOs) on the lowest side of the LHZ arrangement is less than four, so the number of output line 72 is to be four (72-1 to 72-4). On the other hand, the number of input line 71 and the number of the pump line 73 are both to be eight (71-1 to 71-8, and 73-1 to 73-8).

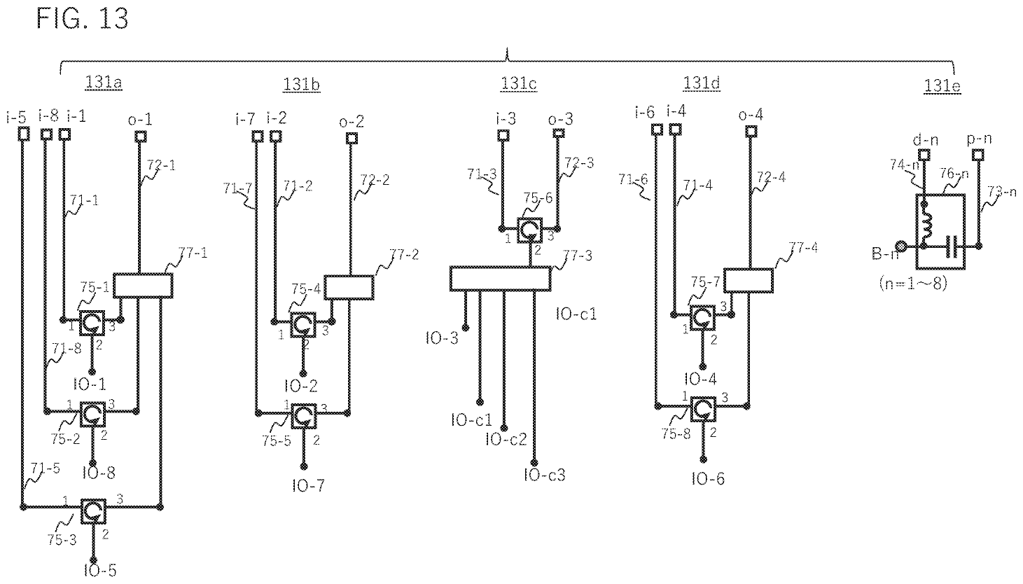

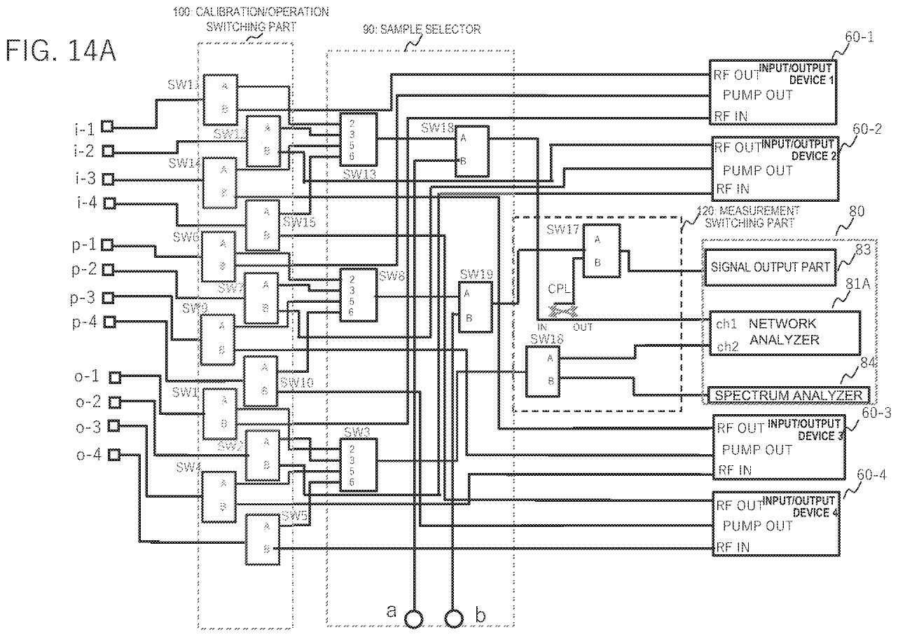

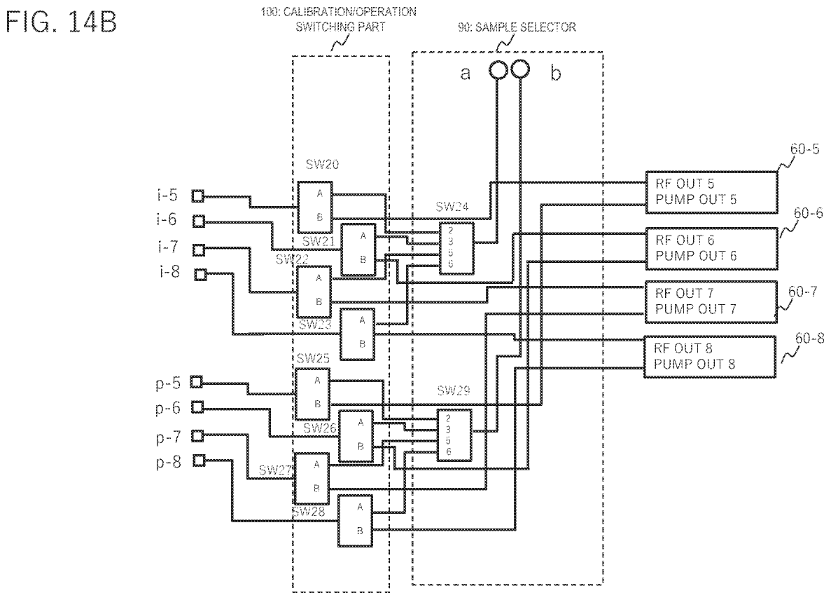

To satisfy above conditions, wirings are done as illustrated in FIG. 13 which 13 illustrate a non-limiting example of connection configuration of input/output ports IO-1 to IO-8 (terminals IO-1 to IO-8) and ports B-1 to B-8 (terminals B-1 to B-8) of the eight JPOs 20-1 to 20-8; and input/output port IO-c1 to IO-c3 (terminals IO-c1 to IO-c3) of the three couplers 21-1 to 21-, in the quantum chip 10 illustrated in FIG. 12, and terminals i-1 to i-8, terminals o-1 to o-8, terminals p-1 to p-8, and terminals d-1 to d-8 (in e.g., FIGS. 14A and 14B).

Referring to FIG. 13, as illustrated in a connection configuration 131a, signals from terminals i-1, i-8, and i-5 are supplied via the input lines 71-1, 71-8, and 71-5 to ports 1 of the circulators 75-1, 75-2, and 75-3, respectively, and via ports 2 of the circulators 75-1, 75-2, and 75-3, supplied to terminals connected to input/output ports IO-1, IO-8, and IO-5 of the JPOs 20-1, 20-8, and 20-5, respectively. Signals from the input/output ports IO-1, IO-8, and IO-5 of the JPOs 20-1, 20-8, and 20-5, are supplied to ports 2 of the circulator 75-1, 75-2, and 75-3, respectively, and supplied via ports 3 of the circulator 75-1, 75-2, and 75-3 to input terminals of a switch 77-1, and the signal selected by the switch 77-1 based on the second control signal 152 from the selector controller 140B in FIG. 4 is supplied via an output line 72-1 to a terminal o-1. That is, the input/output ports IO-1, IO-8, and IO-5 of the JPOs 20-1, 20-8, and 20-5 share the terminal o-1. JPOs 20-1, 20-8, and 20-5 are connected respectively to couplers different from each other. Regarding JPOs 20-1, 20-8, and 20-5, no two combinations thereof (i.e., neither JPOs 20-1 and 20-8, JPOs 20-8 and 20-5, nor JPOs 20-5 and 20-1) are connected to the same coupler. The connection configuration 131a corresponds to a configuration in which at least two or more qubits (JPOs 20-1, 20-5 and 20-8) are connected to the selector (77-1) connected to a first signal line (72-1) and the at least two or more qubits (JPOs 20-1, 20-5 and 20-8) connected to the selector (77-1) are connected respectively to the couplers (21-1, 21-3 and 21-2) which are different from each other.

As illustrated in a connection configuration 131b, signals from terminals i-2 and i-7 are supplied via the input lines 71-2 and 71-7, respectively to ports 1 of the circulators 75-4 and 75-5 and are supplied via ports 2 of the circulators 75-4 and 75-5 to input/output ports IO-2 and IO-7 of the JPOs 20-2 and 20-7, respectively. Signals from the input/output ports IO-2 and IO-7 of the JPOs 20-2 and 20-7 are supplied to ports 2 of the circulator 75-4 and 75-5, respectively and supplied via ports 3 of the circulator 75-4 and 75-5 to input terminals of a switch 77-2 and a signal selected by the switch 77-2 based on the second control signal 152 from the selector controller 140B in FIG. 4 is supplied via an output line 72-2 to a terminal o-2. The input/output ports IO-2 and IO-7 of the JPOs 20-2 and 20-7 share the terminal o-2. JPO 20-7 is connected to the coupler 21-2 and the coupler 21-3, while the JPO 20-2 is connected only to the coupler 21-1. JPO 20-7 and JPO 20-2 are not connected to the same coupler. The connection configuration 131b corresponds to a configuration in which at least two or more qubits (JPOs 20-2 and 20-7) are connected to the selector (77-2) connected to a first signal line (72-2) and the at least two or more qubits (JPOs 20-2 and 20-7) connected to the selector (77-2) are connected respectively to the couplers (21-1 and 21-3) which are different from each other.

As illustrated in a connection configuration 131c, a signal from a terminal i-3 is supplied via an input line 71-3 to a port 1 of the circulator 75-6, supplied via a port 2 of the circulator 75-6 to a switch 77-3, and supplied to a port selected by the switch 77-3 among input/output ports IO-3, IO-c1, IO-c2, and IO-c3 based on the second control signal 152 from the selector controller 140B in FIG. 4. The input/output port IO-3 is an input/output port of the JPO 20-3. The input/output ports IO-c1, IO-c2, and IO-c3 are input/output ports for control signals for the coupler 21-1, 21-2, and 21-3. A signal from the port selected by switch 77-3 from among the input/output port IO-3 of the JPO 20-3, the input/output ports IO-c1, IO-c2, and IO-c3 for control signals of the couplers 21-1, 21-2, and 21-3 is supplied to a port 2 of the circulator 75-6 and supplied via a port 3 of the circulator 75-6 and an output line 72-3 to a terminal o-3. The input/output port IO-3 of the JPO 20-3 and the input/output ports IO-c1 to IO-c3 of the couplers 21-1 to 21-3 share terminals i-3 and o-3. The switch 77-3 corresponds to one example of the second selector described above. The connection configuration 131c corresponds to a configuration in which one qubit (JPO 3) of the plurality of qubits is connected to the first signal line (77-3) via the second selector (77-3), and at least one of the plurality of couplers (21-1, 21-2 and 21-3) is connected to the second selector (77-3). The second selector (77-3) is connected to the first signal line (72-3) via a second circulator (75-6).

As illustrated in a connection configuration 131d, signals from terminals i-4 and i-6 are supplied via the input lines 71-4 and 71-6, respectively, to ports 1 of circulators 75-7 and 75-8 and supplied via ports 2 of the circulators 75-7 and 75-8 to IO ports IO-4 and IO-6 of the JPOs 20-4 and 20-6. Signals from the IO ports IO-4 and IO-6 of the JPOs 20-4 and 20-6, respectively, supplied to the ports 2 of the circulators 75-7 and 75-8 and supplied via ports 3 of the circulators 75-7 and 75-8 to input terminals of a switch 77-4. The signal selected by the switch 77-4 based on the second control signal 152 from the selector controller 140B in FIG. 4 is supplied via an output line 72-4 to a terminal o-4 The input/output ports IO-4 and IO-6 of the JPOs 20-4 and 20-6 share the terminal o-4. JPO 20-4 is connected to the coupler 21-2 and the coupler 21-1, while the JPO 20-6 is connected only to the coupler 21-3. JPO 20-4 and JPO 20-6 are not connected to the same coupler. The connection configuration 131d corresponds to a configuration in which at least two or more qubits (JPOs 20-4 and 20-6) are connected to the selector (77-4) connected to the first signal line (72-4) and the at least two or more qubits (JPOs 20-4 and 20-6) connected to the selector (77-4) are connected respectively to the couplers (21-1 and 21-3) different from each other.

As illustrated in a connection configuration 131e, a DC signal and a pump signal from terminals d-n and p-n (n=1 to 8) connected to a bias T circuit 76-n and supplied to port B-n (magnetic field application part) of the JPOs 20-n.

For switching control of each switch 77 in the refrigerator, known techniques are used. For the switches of the calibration/operation switching part 100, the sample selector 90, and the measurement switching part 120 disposed in the room temperature environment, a high-frequency electromagnetic mechanical relay, such as SP6T and SPDT (Single-Pole Double-Throw) may be used.

As illustrated in FIG. 13, multiple JPOs that are not subjected to parallel (simultaneous) readout, share the output terminal o and switched by each switch (77-1 to 77-4) for performing time-division readout to the shared output terminal o. This reduces the number of output lines (high-frequency coaxial cables) for output signals (reflection signal) from the JPOs in the transmission system to four (o-1 to o-4), thus reducing the number of devices such as circulators, isolators, and HEMT amplifiers arranged on the output line.

Since the JPO requires individual input lines during operation (e.g., annealing), the circulators 75-1, 75-2, 75-3, the circulators 75-4, 75-5, and the circulators 75-7 to 75-8 are disposed on the sample (JPO or coupler) side rather than the switch 77-1, the switch 77-2, and the switch 75-4, respectively. On the other hand, the couplers 21-1 to 21-3 do not require individual input lines because signals are supplied from the ports IO-c1 to IO-c3 only during calibration. Therefore, the number of circulators can be reduced by disposing the switch 77-3 between the circulator 75-6 and the samples (IO port IO-3 of JPO 20-3 and IO-c1-to IO-c3 of couplers 21-1 to 21-3). With the wiring configuration described above, there are eight input lines, four output lines, and eight pump lines at room temperature environment (normal temperature portion outside the refrigerator). As in FIG. 9, the quantum computer apparatus includes a calibration/operation switching part 100, a sample selector 90, and a measurement switching part 120. The switching configuration described with reference to FIG. 13, enables to perform calibration for all eight qubits and all three couplers.

FIG. 14A and FIG. 14B are diagrams illustrating circuits (placed at a room temperature environment) that performs switching between calibration and operation for an annealing machine with eight qubits illustrated in FIG. 12 which is an 8-bit version corresponding to the 4-bit one illustrated in FIG. 9. The drawing is divided into two drawings connected by connection terminals a and b for convenience of drawing.

Each switch SW1, SW2, SW4 to SW7, SW9 to SW12, SW14, and SW15 of the calibration/operation switching part 100 connect terminals i-1 to i-4, o-1 to o-4, and p-1 to p-8 to the measurement system 80 in calibration and connect terminals i-1 to i-4, o-1 to o-4, and p-1 to p-4, to the input/output devices 60-1 to 60-4, respectively, in operation.

Each switch SW20 to SW23, and SW25 to SW28 of the calibration/operation switching part 100 connect terminals i-5 to i-8, and p-5 to p-8 to the measurement system 80 in calibration and connect to the input/output devices 60-5 to 60-6, respectively, in operation. The input/output device 60-5 to 60-6 includes a signal output part (RF OUT) and a pump signal output part (PUMP OUT) but does not include a signal output part.

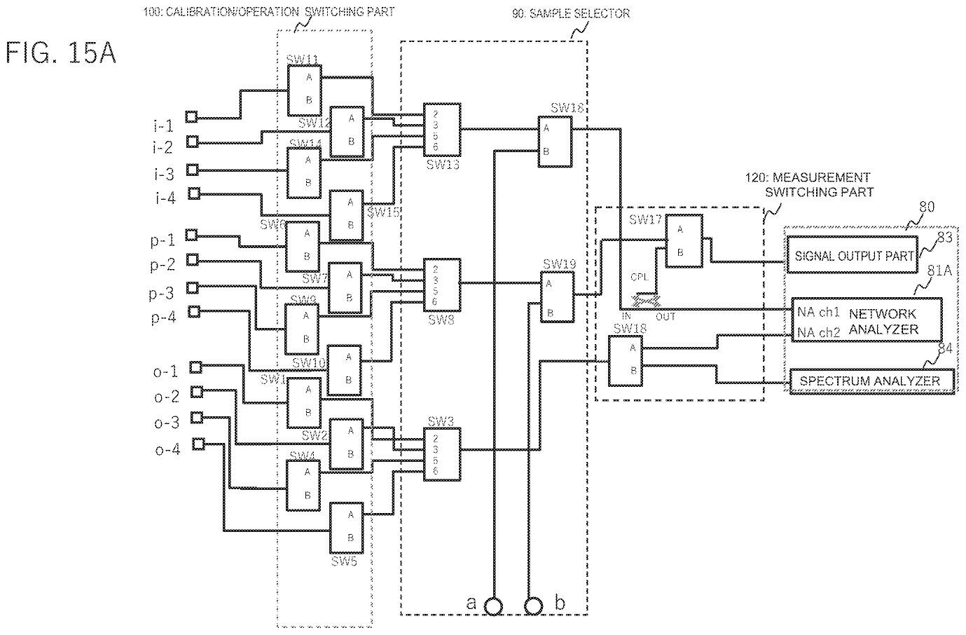

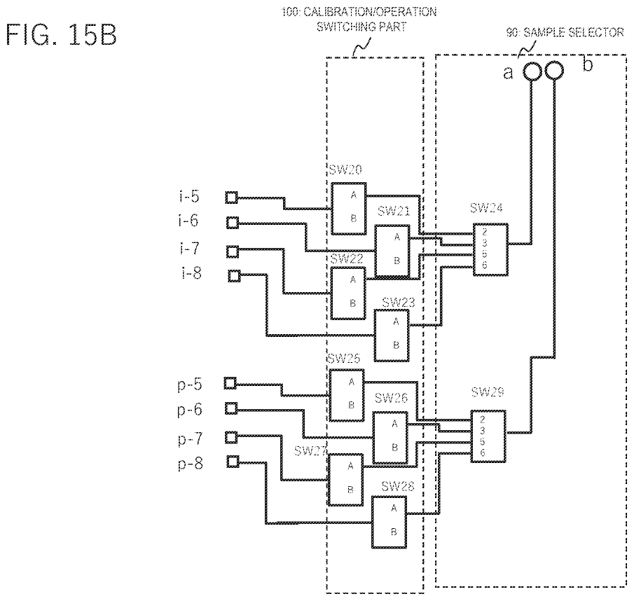

FIG. 15A and FIG. 15B are diagrams illustrating a connection configuration during calibration in a configuration illustrated in FIG. 14A and FIG. 14B. Each switch of the calibration/operation switching part 100 is switched to a terminal A based on the first control signal 151 (operation switching signal in FIG. 6) in FIG. 4, and switches SW3, SW8, SW13 SW24 and SW29 of the sample selector 90 select one of pairs of terminals (i-1, o-1, and p-1) and (i-4, o-4, and p-4) and connect to the measurement system 80 via the measurement switching part 120.

Switches SW18 and SW19 of the sample selector 90 select one of pairs of terminals (i-5 and p-5) and (i-8 and p-8) based on the first control signal 151 (sample selection signal in FIG. 6) and connect to the measurement system 80 via the measurement switching part 120. The measurement switching part 120 has been described above, so its explanation is omitted.

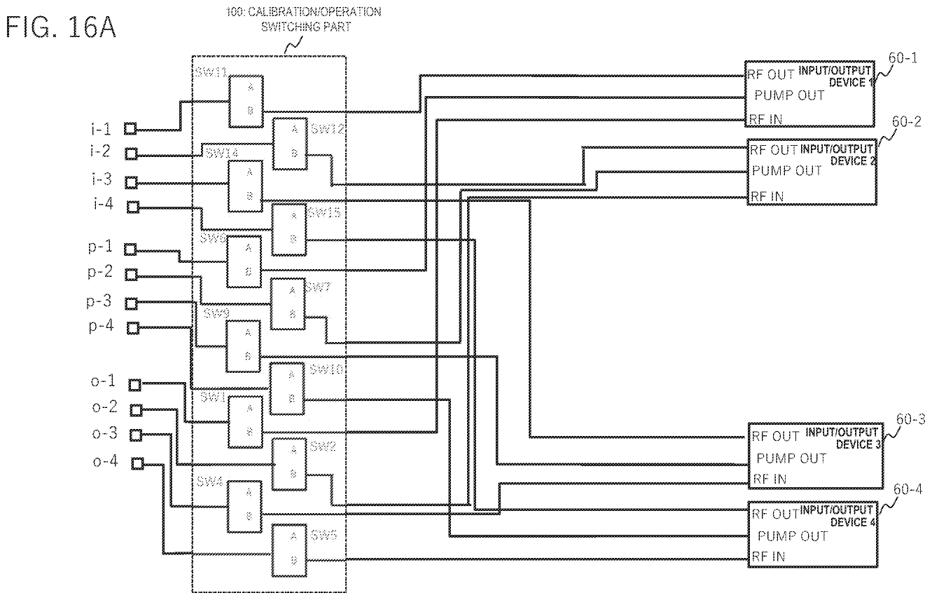

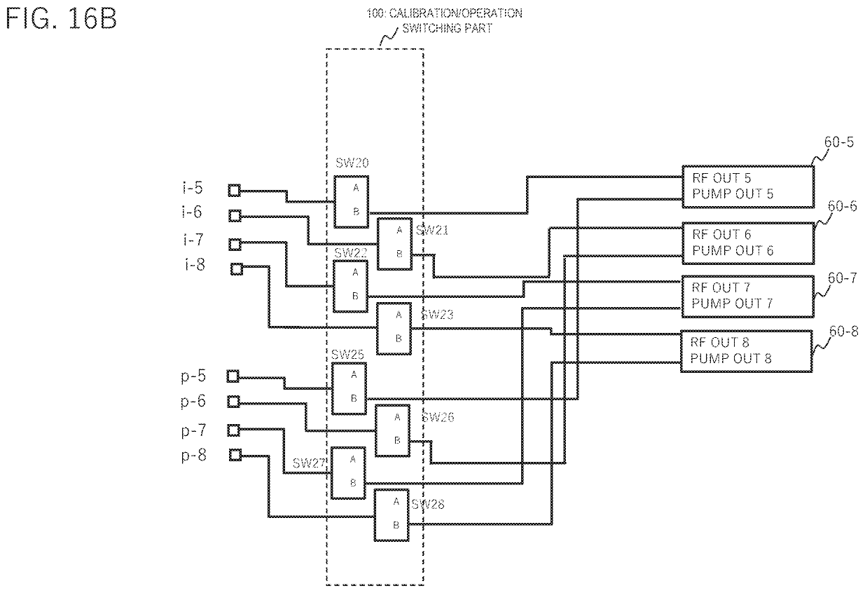

FIG. 16A and FIG. 16B are diagrams illustrating a connection configuration during operation in a configuration illustrated in FIG. 14A and FIG. 14B. Each switch of the calibration/operation switching part 100 is switched to a terminal B based on the first control signal 151 (operation switching signal in FIG. 6) in FIG. 4.

First, a pre-operation adjustment is performed. The pre-operation adjustment is performed by connecting the JPOs 20-1, 20-2, 20-3, and 20-4 to the input/output devices 60-1, 60-2, 60-3, and 60-4, respectively. That is, the terminal IO-1 (FIG. 12) of the JPO 20-1 is connected to the terminal o-1 via the circulator 75-1 and the selector 77-1 illustrated as the configuration 131a in FIG. 13. The terminal IO-2 (FIG. 12) of the JPO 20-2 is connected to the terminal o-2 via the circulator 75-4 and the selector 77-2 illustrated as the configuration 131b in FIG. 13. The terminal IO-3 (FIG. 12) of the JPO 20-3 is connected to the terminals i-1 and o-3 via the selector 77-3 and the circulator 75-6 illustrated as the configuration 131c in FIG. 13 The terminal IO-4 (FIG. 12) of the JPO 20-4 is connected to the terminal o-4 via the circulator 75-7 and the selector 77-4 illustrated as the configuration 131d in FIG. 13. As illustrated in FIG. 16A, pairs of terminals (i-1, p-1, and o-1) to (i-4, p-4, and o-4) that connect to the JPOs 20-1 to 20-4 are connected to RF OUT, RF IN, and PUMP OUT of the input/output devices 60-1 to 60-4, respectively.

Next, the JPOs 20-8, 20-7, 20-3, and 20-4 respectively selected by the selectors 77-1, 77-2, 77-3, and 77-4 in FIG. 13 are connected to the input/output device corresponded for pre-operation adjustment. JPOs 20-8, 20-7, 20-3, and 20-4 are respectively selected based on the second control signal 152 in FIG. 4. That is, the terminal IO-8 of the JPO 20-8 is connected to the terminal o-1 via the circulator 75-2 and the selector 77-1.

Regarding the set of terminals (i-8, p-8, and o-1) connected to the JPO 20-8, i-8 and p-8 are connected to the RF OUT and the PUMP OUT of the input/output device 60-8 illustrated in FIG. 16B, respectively, and o-1 is connected to the RF IN of the input/output device 60-1 illustrated in FIG. 16A. The terminal IO-7 of the JPO 20-7 is connected to the terminal o-2 via the circulator 75-5 and the selector 77-2.

Regarding the set of terminals (i-7, p-7, and o-2) connected to the JPO 20-7, i-7 and p-7 are connected to the RF OUT and the PUMP OUT of the input/output device 60-7 illustrated in FIG. 16B, respectively, and o-2 is connected to the RF IN of the input/output device 60-2 illustrated in FIG. 16A. The terminal IO-3 of the JPO 20-3 is connected to the terminals i-3 and o-3 via the selector 77-3 and the circulator 75-6, and the set of terminals (i-3, p-3, and o-3) are connected to the RF OUT, the PUMP OUT, and the RF-IN of the input/output device 60-3 illustrated in FIG. 16A. The terminal IP-4 of the JPO 20-4 is connected to the terminal o-4 via the circulator 75-7 and the selector 77-4. the pairs of terminals (i-4, p-4, and o-4) connected to the JPO 20-4 are connected to the RF OUT, the PUMP OUT and the RF IN of the input/output device 60-4 illustrated in FIG. 16A.

Next, the JPOs 20-5, 20-7, 20-3, and 20-6 respectively selected by the selectors 77-1, 77-2, 77-3, and 77-4 in FIG. 13A, FIG. 13B, FIG. 13C and FIG. 13D are connected to the input/output device to perform pre-operation adjustment. That is the terminal IO-5 of the JPO 20-5 is connected to the terminal o-1 via the circulator 75-3 and the selector 77-1.

Regarding the set of terminals (i-5, p-5, and o-5) connected to the JPO 20-5, i-5 and p-5 are connected to the RF OUT and the PUMP OUT of the input/output device 60-5 illustrated in FIG. 16B, respectively, and o-1 is connected to the RF IN of the input/output device 60-1 illustrated in FIG. 16A. The terminal IO-7 of the JPO 20-7 is connected to the terminal o-2 via the circulator 75-5 and the selector 77-2. Among the pairs of terminals (i-7, p-7, and o-2) connected to the JPO 20-7, i-7 and p-7 are connected to the RF OUT and the PUMP OUT of the input/output device 60-7 illustrated in FIG. 16B, respectively, and o-2 is connected to the RF IN of the input/output device 60-2 illustrated in FIG. 16A. The terminal IO-3 of the JPO 20-3 is connected to the terminals i-1 and o-3 via the selector 77-3 and the circulator 75-6. Pairs of terminals (i-3, p-3, and o-3) that connect to the JPO 20-3 are connected to the RF OUT, the RF IN, and the PUMP OUT of the input/output devices 60-3, respectively. The terminal IO-4 of the JPO 20-7 is connected to the terminal o-4 via the circulator 75-7 and the selector 77-4.

The set of terminals (i-4, p-4, and o-4) connected to the JPO 20-4 are connected to the RF OUT, the PUMP OUT, and the RF-IN of the input/output device 60-4 illustrated in FIG. 16A.

Then, JPOs 20-1, 20-3, and 20-6 of the lowest side are connected to the input/output device for calculation. The set of terminals (i-1, p-1, and o-1) and (i-3, p-3, and o-3), to which JPOs 20-1 and 20-3 are connected, are respectively connected to the RF OUT, the RF IN, and the PUMP OUT of the input/output device 60-1 illustrated in FIG. 16A. The terminal IO-6 (FIG. 16) of the JPO 20-6 is connected to the terminal o-4 via the circulator 7508 and the selector 77-4 illustrated in FIG. 13D. Regarding the set of terminals (i-6, p-6, and o-4) connected to the JPO 20-6, i-6 and p-6 are connected to the RF OUT and the PUMP OUT of the input/output device 60-6 illustrated in FIG. 16B, respectively, and o-4 is connected to the RF IN of the input/output device 60-4 illustrated in FIG. 16A.

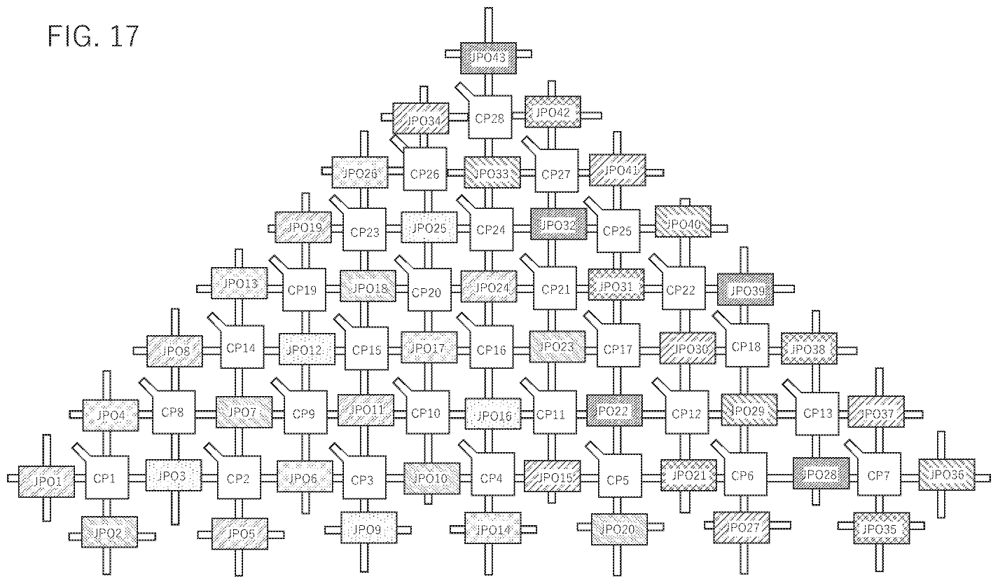

The following describes, as a system larger than eight bits, in particular, a 43-bit annealing machine. In this case, the number of qubits required for simultaneous readout is 8, and 8 readout lines are provided. FIG. 17 is a diagram schematically illustrating which qubits are grouped together on the same readout line in a 43-bit annealing machine. JPOs of the same pattern (pattern in the box) are connected to a switch that leads to the same readout line. Here, the JPOs with the same pattern of boxes are not connected to the same coupler in any two combinations. For example, JPO 7 is connected to four couplers (CP8, CP14, CP9, and CP2), but JPO 2, JPO 18, JPO 10, JPO 23, and JPO 20, which have the same pattern as the JPO 7, are not connected to any of these four couplers (CP8, CP14, CP9, and CP2). Note that a system larger than eight bits may be implemented as a three-dimensional wiring structure in which I/O ports and pump ports are provided in different ways, and port locations are omitted. As illustrated in FIG. 17, the number of readout lines can be reduced in a similar manner for larger systems by grouping the readout lines in a regular manner. Regarding readout of the coupler, there are no restrictions on simultaneous readout and the coupler may be connected to any of the readout lines.

Regarding to wirings placed in a room temperature environment, the same configuration can be applied as the calibration up to eight bits. In the case of 43 bits, there will be 43 input lines, eight output lines, and 43 pump lines. For each of these, a calibration/operation switching part, a sample selector, and a measurement switching part are provided. This makes it possible to calibrate all qubits and couplers in the same way. JPOs with the same pattern are connected to a switch (selector) that connects to the same readout line.

In FIG. 17, two lines appear alternately when viewed diagonally to the right. For example, on a diagonal side of a left edge, JPO 1 and JPO 4, JPO 8 and JPO 13, JPO 19 and JPO 26, and JPO 34 (having the same up-right diagonal stripe pattern as the JPO 1, but with different shading) and JPO 43 (having the same dotted line pattern as the JPO 4, but different shading) are arranged. The input/output ports of the JPO 1, JPO 8, JPO 19, JPO 26, and JPO 34 are connected to a single switch to connect to a signal input part (readout circuit). The input/output ports of the JPO 4, JPO 13, JPO 26, JPO 34, and JPO 43 are connected to a switch other than the switch to which the JPO 1, JPO 8, JPO 19, JPO 26, and JPO 34 are connected to connect to the signal input part (readout circuit). Lines parallel to this appear alternating with lines that differ from it. JPO 2 and JPO 3, JPO 7 and JPO 12, JPO 18 and JPO 25, and JPO 33 and JPO 42 are arranged. JPO 1, JPO 3, JPO 6, JPO 10, JPO 15, JPO 21, JPO 28, and JPO 36, which perform simultaneous readouts, must be connected to different readout lines from each other. However, for the other JPOs, the combination of light shading JPO and dark shading JPO (e.g., JPO 8 and JPO 30) may be swapped as long as the pattern of the boxes representing the JPOs are the same.

The following describes a brief overview of an example of drive power calibration (converting a power of a signal output from a device to an actual drive strength applied to the device) using an input signal to an IO port of the JPO.

The Hamiltonian (quantized Hamiltonian) H of one JPO (JPO 1) is given, for example, as a following equation (3).

$$\frac{ℋ}{ℏ} = {ω}_{1} {a}_{1}^{†} {a}_{1} - \frac{{χ}_{1}}{12} {( {a}_{1} + {a}_{1}^{†} )}^{4} + 2 {β}_{1} cos ( {ω}_{p , 1} t ) {( {a}_{1} + {a}_{1}^{†} )}^{2} + 2 {λ}_{1} cos ( {ω}_{d , 1} t + {θ}_{d , 1} ) ( {a}_{1}^{†} + {a}_{1} ) \qquad ( 3 )$$

In the equation (3),
hbar is a Dirac's constant.
a₁⁺ and a₁ are a creation operator and an annihilation operator of a microwave photon, respectively.
ω₁ is a resonance angular frequency of the JPO 1.
ω_{p, 1} is an angular frequency of a pump signal of the JPO 1.
ω_{d, 1} is an angular frequency of a drive signal of the JPO 1.
θ_{d, 1} is a phase of the drive signal and xi is a nonlinearity.
β₁ is a parametric drive strength (or intensity) (amplitude of pump field).
λ₁ is a coherent drive strength (or intensity).

In the equation (3), β₁ and λ₁ are given as following equations (4) and (5).

$${λ}_{1} = \sqrt{\frac{{κ}_{e} ( Hz ) 1 {0}^{\frac{{\overline{p}}_{d} ( d B m )}{10}}}{ℏω ( J ) \times 1000}} \qquad ( 4 )$$

$${β}_{1} = π \vert \frac{df}{di} \vert ( \frac{Hz}{A} ) \sqrt{\frac{2}{{Z}_{0} \times 1000}} 1 {0}^{\frac{{\overline{p}}_{p} ( d B m )}{20}} \qquad ( 5 )$$

In the equations (4) and (5),
κₑ is an external loss rate (a rate at which the microwave photon is lost from the JPO 20 (a rate at which the photon exits to a loss channel (transmission line 25 in FIG. 5B)), also called decay rate).
df/di is a value obtained by differentiating a resonance frequency f of the JPO 20 by a current value i (a current value supplied to a pump port B of the JPO 20).
P⁻_{d} and p⁻ₚ are powers of the coherent drive and the parametric drive, respectively.
Zo is a characteristic impedance of a line (25 in FIG. 5B).
J stands for Joule, Hz for Hertz, dBm is a unit of power expressed in decibel (dB) values with 1 milliwatt (mW) as the reference value, 0 [dBm]=1 mW, and A for Ampere.

To derive β₁ and λ₁ using the equations (4) and (5), κₑ and df/di are needed to be obtained from the JPO 20 reflection measurements using the network analyzer and/or its magnetic field dependence, and then, pa and pop are obtained with high accuracy, taking into account line attenuation and other factors. In particular, it is difficult to accurately determine the attenuation of an input line due to individual differences in coaxial cables. For this reason, methods have been proposed to determine this drive strength itself directly from a measurement of a reflection signal (reference may be made to e.g., NPLs 3 and 4). On reception of a parametric drive and/or a coherent drive as an input, the resonance frequency of the JPO 20 changes. By comparing a theoretical calculation of the change of the resonance frequency with a measurement result using a computer (not shown), it is possible to determine β₁ and λ₁ more accurately. The computer (not shown) that performs a calibration process may be configured to communicatively connect to the network analyzer 81A and the spectrum analyzer 84 of the measurement system 80 via a GPIB (General Purpose Interface Bus) or a USB (Universal Serial Bus). Alternatively, the computer (not shown) may be configured to connect to the network analyzer 81A and the spectrum analyzer 84 of the measurement system 80 using LAN (Local Area Network) such as Ethernet to connect using TCP/IP (Transmission Control Protocol/Internet Protocol) or other communication protocols.

In one of example embodiments of the present disclosure, along with (or separately from) the calibration of the JPO 20 and the coupler 21, input signals may be applied to the JPO 20 and the coupler 21, and from the output signals (reflection signals), S-parameters, self-resonance frequency, Q-value, coupling coefficient, etc. of the JPO 20 and the coupler 21 may be obtained at the network analyzer 81A (vector network analyzer), inspected, and evaluated. In the same way as for calibration, each switch of the calibration/operation switching part 100 is switched to the A terminal in the case of inspection and evaluation.

In the above example embodiments, a case that a JPO of a lumped element type circuit with a cross-shaped electrode as illustrated in FIG. 7, FIG. 8, FIG. 12, etc., is used for a qubit is described as an example. However, the planar shape of the electrode is, as a matter of course, not limited to a cross shape. The JPO is not limited to the lumped element type circuit but may also be of the distributed element type circuit.

In the above example embodiments, an example that the control part is configured by the selector controller, the switching controller, and the controller that controls the entire system is described. However, the control part is not limited to the configuration configured with three parts but may be separated into a main controller and an external controller, for example. The external control part may be, for example, a PC (Personal Computer) or the like. An L2 switch, and/or a router (L3 switch), etc., may be provided between the main control part and the external control part to connect to the network. The main control part may be connected to a LAN or the Internet so that one or more external users can operate it via these networks. In such a case, a job management server may receive requests from external users and transmit a designated command to the main control unit while managing the entire jobs.

In the above example embodiments, the sample selector 90 and the measurement switching part 120 are configured as separate units from the measurement system 80. However, the sample selector 90 and the measurement switching part 120 may be configured as a single unit.

In the above example embodiments, an example of switching between calibration and operation is described. However, only one of testing and calibration may be performed without performing the switching. In this case, signal input/output parts whose number is the same as the number of qubits need not necessarily be provided. The measurement system is not limited to be used for testing and calibration, but can also be used for characteristic evaluation and/or calculation.

In the above example embodiments, a wiring reduction in the refrigerator has been described as one example, but the effect of the wiring reduction is not limited thereto and can also contribute to a use of chambers without refrigerating function, for example.

The above examples of the disclosure may partially or entirely be described as following Supplementary notes (Notes), though not limited thereto.

### (Note 1)

A quantum circuit comprises: a plurality of qubits; a plurality of couplers; a first signal line; and a first selector connected to the first signal line. Each qubit is connected to one or more of the plurality of couplers, at least two or more of the plurality of qubits are connected to the first selector. The at least two or more qubits connected to the first selector are connected respectively to the couplers that are different from each other.

### (Note 2)

In the quantum circuit according to Note 1, the quantum circuit comprises four first signal lines. Four of the plurality of qubits are connected to each of the couplers. The four qubits are respectively connected to the four first signal lines that are different from each other.

At least one of the four qubits is connected to the first signal line (or the four first signal lines) via the first selector.

### (Note 3)

In the quantum circuit according to Note 1 or 2, the at least two or more qubits connected to the first selector are connected to the first selector via a first circulator.

The quantum circuit further comprises a second signal line connected to the at least two or more qubits via the first circulator.

### (Note 4)

In the quantum circuit described any one of Notes 1 to 3, the plurality of qubits is arranged in LHZ scheme.

### (Note 5)

In the quantum circuit according to any one of Notes 1 to 4, a qubit of the plurality of qubits includes a resonator that includes a loop circuit including at least two Josephson junctions.

### (Note 6)

A quantum circuit according to any one of Notes 1 to 5 includes: a plurality of qubits; at least one coupler; a first signal line, and a second selector.

A qubit of the plurality of qubits is connected to one or a plurality of coupler(s) of the at least one coupler.

One of the plurality of qubits is connected to the first signal line via the second selector.

At least one of the plurality of couplers is connected to the second selector.

### (Note 7)

In the quantum circuit according to Note 6, the second selector is connected to the first signal line via a second circulator.

### (Note 8)

A quantum computer apparatus, includes: the quantum circuit according to Note 3 or 7 and
a switching part that switches between a first connection configuration and a second connection configuration, wherein the first connection configuration is configured to connect the first signal line and the second signal line to a measurement system, and the second connection configuration is configured to connect the first signal line and the second signal line to a group of input/output devices.

### (Note 9)

In the quantum computer apparatus according to Note 8, the switching part includes: a sample selector that selects the qubit to be measured; and a measurement switching part that switches mode of measurement.

The measurement switching part switches between at least two modes among a first measurement mode, a second measurement mode, and a third measurement mode.

The first measurement mode is configured to supply a signal from a first signal output part of the measurement system to the second signal line connected to the qubit selected by the sample selector, to supply a signal from a second signal output part of the measurement system to the qubit selected by the sample selector as a pump signal, and to output a signal from the first signal line connected to the qubit to a first signal input part of the measurement system.

The second measurement mode is configured to supply a signal resulting from combining signals from the first signal output part and the second signal output part of the measurement system to the second signal line connected to the qubit selected by the sample selector, and to supply a signal from the first signal line connected to the qubit selected by the sample selector to the first signal input part of the measurement system.

The third measurement mode is configured to supply a signal from the second signal output part of the measurement system to the qubit selected by the sample selector as a pump signal, and to supply a signal from the first signal line connected to the qubit selected by the sample selector to a second signal input part of the measurement system.

### (Note 10)

In the quantum computer apparatus according to Note 9, the measurement switching part is arranged between the measurement system and the sample selector.

The measurement system comprises: the second signal output part; a network analyzer that includes the first signal output part and the first signal input part; and a spectrum analyzer that includes the second signal input part.

### (Note 11)

In the quantum circuit according to any one of Notes 1 to 7, at least one qubit of the plurality of qubits is connected to the plurality of couplers, and no combination of any two of the at least two or more qubits connected to one first selector is connected to the same coupler.

### (Note 12)

A quantum circuit includes a plurality of qubits, at least one coupler, a first signal line and a second selector.

A qubit of the plurality of qubits is connected to one or a plurality of couplers of the at least one coupler. One of the plurality of qubits is connected to the first signal line via the second selector. At least one of the plurality of couplers is connected to the second selector.

### (Note 13)

In the quantum circuit according to Note 12, the second selector is connected to the first signal line via a second circulator, and the second circulator is connected to a second signal line.

### (Note 14)

A quantum computer apparatus includes the quantum circuit according to Note 13; and a switching part that switches between a first connection configuration and a second connection configuration.

The first connection configuration is configured to connect the first signal line and the second signal line to a measurement system.

The second connection configuration is configured to connect the first signal line and the second signal line to a group of input/output devices.

### (Note 15)

A quantum computer apparatus includes in a refrigerator;
one or more unit structures (plaquettes) that has a configuration that four qubits are coupled with each other by a four-body interaction via a coupler;
output lines the number of which is equal to the greater of the number of qubits to be read out simultaneously or four;
an input line that is disposed corresponding to each qubit and inputs a signal to an input/output port of each qubit;
a pump line that is disposed corresponding to each qubit and supplies a pump signal to each qubit; and
an input/output port for input/output a signal to/from the coupler;
and a second selector that selects one of the input/output ports of at least one qubit that is connected to the coupler and is not subject to simultaneous readout.

The quantum computer apparatus including, in a room temperature environment outside of the refrigerator,
a switching part that includes a group of switches that switches between connecting the input line, the output lines and the pump line to a measurement system for a measurement of the qubits or the couplers, and connecting the input line, the output lines and the pump line to a signal input/output part for quantum annealing operation.

The quantum computer apparatus is capable of switching between the measurement for inspection or calibration of all bits of the qubits of the one or more unit structures (plaquettes) and the quantum annealing operation.

### (Note 16)

In the quantum computer apparatus according to Note 15, a plurality of first circulator in which a second port is connected to an input/output port of a corresponding qubit and at least one second circulator in which a second port is connected to a corresponding selector, are included in the refrigerator as a circulator in which a first port is connected to the input line and a third port is connected to the output lines.

The second selector connects the input/output port selected to the second port of the second circulator.

The first circulator outputs from the second port a signal input from the input line to the first port to supply the signal to the input/output port of the qubits.

The second circulator outputs from the second port a signal input from the input line to the first port to supply the signal to the second selector during signal application.

The first circulator and the second circulator output signals input from the second port to the output lines from the third port at a time of readout.

### (Note 17)

The quantum computer apparatus according to Note 15 or 16 further includes a first selector in the refrigerator that selects one of the plurality of input/output ports of the plurality of qubits that are not subject to simultaneous readout.

The first selector connects the input/output port selected to the second port of the second circulator corresponded.

### (Note 18)

The quantum computer apparatus according to one of Notes 15 to 17, further includes a plurality of input/output ports of a plurality of couplers and a third selector to select any one of at least one input/output port of the qubit that is connected to at least one of the plurality of couplers and is not subject to simultaneous readout, in said refrigerator. The third selector connects the input/output port selected to the second port of the second circulator corresponded.

### (Note 19)

The quantum computer apparatus according to one of Notes 15 to 18 includes a sample selector to select the qubits to be measured, in the room temperature environment.

### (Note 20)

The quantum compute apparatus according to Note 19 includes a measurement switching part that switches the measurement modes in the room temperature environment.

The measurement switching part switches between at least two modes among a first measurement mode, a second measurement mode and a third measurement mode.

The first measurement mode is configured to supply a signal from a first signal output part of the measurement system to an input/output port of the qubit selected by the sample selector, to supply a signal from a second signal output part of the measurement system to the qubit selected by the sample selector as a pump signal, and to output a signal from the input/output port of the qubit to a first signal input part of the measurement system.

The second measurement mode is configured to supply a signal resulting from combining signals from the first signal output part and the second signal output part of the measurement system to t an input/output port of the qubit selected by the sample selector, and to supply a signal from the input/output port of the qubit selected by the sample selector to the first signal input part of the measurement system.

The third measurement mode is configured to supply a signal from the second signal output part of the measurement system to the qubit selected by the sample selector as a pump signal, and to supply a signal from the input/output port of the qubit selected by the sample selector to a second signal input part of the measurement system.

### (Note 21)

In the quantum computer apparatus according to Note 20, the measurement switching part is disposed between the measurement system and the sample selector.

The measurement system includes the second signal output part, a network analyzer that includes the first signal output part and the first signal input part, and a spectrum analyzer that includes the second signal input part.

### (Note 22)

The quantum computer apparatus according to one of Notes 15 to 21 includes a plurality of unit structures (plaquettes). A unit structure of the plurality of unit structures shares at least one qubit of the four qubits that configures the unit structure with one or more other unit structure of the plurality of unit structure.

### (Note 23)

In the quantum computer apparatus according to one of Notes 15 to 22, the plurality of qubits is arranged in the LHZ scheme. The number of the output lines is equal to the greater one of the number of qubits on the lowest side and four.

### (Note 24)

In the quantum computer apparatus according to one of Notes 15 to 23, the qubits include Josephson parametric oscillators, respectively.

The disclosure of each of NPL 1 to 4 is incorporated herein by reference thereto. Variations and adjustments of the example embodiments and examples are possible within the scope of the overall disclosure (including the claims) of the present invention and based on the basic technical concept of the present invention. Various combinations and selections of various disclosed elements (including the elements in each of the claims, examples, drawings, etc.) are possible within the scope of the claims of the present invention. The present disclosure, as a matter of course, includes various variations modifications and combination of the examples that could be made by those skilled in the art according to the overall disclosure including the claims and the technical concept.

What is claimed is:

1. A quantum circuit comprising:
a plurality of qubits;
a plurality of couplers;
a first signal line; and
a first selector connected to the first signal line,
wherein an individual one of the plurality of qubits is connected to at least one of the plurality of couplers, and
at least two or more of the plurality of qubits are connected to the first selector, the at least two or more qubits connected to the first selector being connected respectively to the couplers different from each other.

2. The quantum circuit according to claim 1, wherein the first signal line includes four first signal lines, and the first selector includes four first selector,
wherein the coupler is configured to connect to neighboring four qubits of the plurality of qubits,
the four qubits are connected to the four first signal lines, respectively, and
at least one of the four qubits is connected to at least one of the four first signal lines via at least one of the four first selectors.

3. The quantum circuit according to claim 1, further comprising
a first circulator, the qubit connected to the first selector being connected to the first selector via the first circulator; and
a second signal line connected to the qubit via the first circulator.

4. The quantum circuit according to claim 1, wherein the plurality of qubits is arranged in LHZ (Lechner, Hauke, Zoller) scheme.

5. The quantum circuit according to claim 1, wherein the qubit includes a resonator that includes a loop circuit including at least two Josephson junctions.

6. A quantum circuit comprising:
a plurality of qubits;
at least one coupler;
a first signal line, and
a second selector,
wherein an individual one of the plurality of qubits is connected to a coupler or a plurality of couplers of the at least one coupler,
one of the plurality of qubits is connected to the first signal line via the second selector, and
at least one of the plurality of couplers is connected to the second selector.

7. The quantum circuit according to claim 6, wherein the second selector is connected to the first signal line via a second circulator.

8. A quantum computer apparatus comprising:
a quantum circuit that includes:
a plurality of qubits;
a plurality of couplers;
a first signal line;
a second signal line;
a first circulator; and
a first selector connected to the first signal line,
wherein an individual one of the plurality of qubits is connected to at least one of the plurality of couplers, and
at least two or more of the plurality of qubits are connected to the first selector, the at least two or more qubits connected to the first selector being connected respectively to the couplers different from each other, and
wherein the qubit connected to the first selector is connected to the first selector via the first circulator, and
the second signal line is connected to the qubit via the first circulator, the quantum computer apparatus further comprising
a switching part that switches between a first connection configuration and a second connection configuration,
wherein in the first connection configuration, the first signal line and the second signal line are connected to a measurement system, and
in the second connection configuration, the first signal line and the second signal line are connected to a group of input/output devices.

9. The quantum computer apparatus according to claim 8, wherein the first signal line includes four first signal lines, and the first selector includes four first selector, and
wherein the coupler is configured to connect to neighboring four qubits of the plurality of qubits,
the four qubits are connected to the four first signal lines, respectively, and
at least one of the four qubits is connected to at least one of the four first signal lines via at least one of the four first selectors.

10. The quantum computer apparatus according to claim 8, wherein the quantum circuit comprises
a second selector that selects one from among at least one qubit connected to the second selector out of the plurality of qubits and at least one coupler connected to the second selector out of the plurality of couplers and connects the selected one to the first signal line.

11. The quantum computer apparatus according to claim 8, wherein the qubit includes
a resonator that includes a loop circuit including at least two Josephson junctions.

12. The quantum computer apparatus according to claim 8, wherein the switching part comprises:
a sample selector that selects the qubit to be measured; and
a measurement switching part that switches between at least two modes among a first measurement mode, a second measurement mode, and a third measurement mode,
wherein the first measurement mode is configured to supply a signal from a first signal output part of the measurement system to the second signal line connected to the qubit selected by the sample selector, to supply a signal from a second signal output part of the measurement system to the qubit selected by the sample selector as a pump signal, and to supply a signal from the first signal line connected to the qubit to a first signal input part of the measurement system,
wherein the second measurement mode is configured to supply a signal obtained by combining signals from the first signal output part and the second signal output part of the measurement system to the second signal line connected to the qubit selected by the sample selector, and to supply a signal from the first signal line connected to the qubit selected by the sample selector to the first signal input part of the measurement system, and
wherein the third measurement mode is configured to supply a signal from the second signal output part of the measurement system to the qubit selected by the sample selector as a pump signal, and to supply a signal from the first signal line connected to the qubit selected by the sample selector to a second signal input part of the measurement system.

13. The quantum computer apparatus according to claim 12, wherein the measurement switching part is arranged between the measurement system and the sample selector,
wherein the measurement system comprises:
the second signal output part;
a network analyzer that includes the first signal output part and the first signal input part; and
a spectrum analyzer that includes the second signal input part.

14. The quantum computer apparatus according to claim 8, wherein the first circulator includes:
a first port connected via the second signal line to a first terminal of the switching part;
a second port connected via the first selector and the first signal line to a second terminal of the switching part; and
a third port connected to an IO port of the qubit.

15. The quantum computer apparatus according to claim 11, comprising
a second circulator including:
a first port connected via the second signal line to a third terminal of the switching part;
a second port connected to the second selector;
a third port connected via the first signal line to a fourth terminal of the switching part,
wherein the second selector select one from among one or more qubits connected to the second selector, and at least one of the plurality of couplers connected to the second selector to connect the selected one to the second port of the second circulator, the third port thereof connected to the first signal line.

16. The quantum computer apparatus according to claim 8, wherein number of the first signal lines is equal to a greater one between number of qubits on a lowest side of the plurality of qubits arranged in LHZ (Lechner, Hauke, Zoller) scheme and 4, and
number of the second signal lines is equal to total number of qubits.
